(19) United States
(12) Patent Application Publication
(10) Pub. No.: US 2026/0129552 A1
(43) Pub. Date: May 7, 2026

(54) SYSTEMS AND METHODS FOR WI-FI NETWORK EVALUATION

(71) Applicant: COGNITIVE SYSTEMS CORP., Waterloo (CA)

(72) Inventors: Chris BEG, Waterloo (CA); Mohammad OMER, Waterloo (CA)

(21) Appl. No.: 19/116,261

(22) PCT Filed: Sep. 28, 2023
(86) PCT No.: PCT/IB2023/059707

§ 371 Date: Mar. 27, 2025

Related U.S. Application Data
(60) Provisional application No. 63/377,633, filed on Sep. 29, 2022.
(60) Provisional application No. 63/381,656, filed on Oct. 31, 2022.

(51) Int. Cl. H04W 40/24; H04W 16/28; H04W 24/10; H04W 52/36

(52) U.S. Cl. CPC H04W 40/246; H04W 16/28; H04W 24/10; H04W 52/367

(57) ABSTRACT

Systems and methods for Wi-Fi network evaluation are provided. The methods may be carried out by a networking device operating within a Wi-Fi network including a plurality of stations and a plurality of access points. The networking device may identify a communication link topology of the Wi-Fi network defined by a plurality of communication links between an associated pair of stations and access points. The networking device may receive a plurality of sensing measurements measured according to the communication link topology. A proximity link topology of the Wi-Fi network may be determined based on the plurality of sensing measurements and used to adjust the Wi-Fi network.

### RELATED APPLICATIONS

This application claims priority to U.S. Provisional Application No. 63/377,633, filed Sep. 29, 2022, and to U.S. Provisional Application No. 63/381,656, filed Oct. 31, 2022, both of which are hereby incorporated herein in their entirety.

### TECHNICAL FIELD

The present disclosure generally relates to systems and methods for Wi-Fi sensing. In particular, the present disclosure relates to systems and methods for Wi-Fi network evaluation.

### BACKGROUND OF THE DISCLOSURE

Motion detection systems have been used to detect movement, for example, of objects in a room or an outdoor area. In some example motion detection systems, infrared or optical sensors are used to detect movement of objects in the sensor's field of view. Motion detection systems have been used in security systems, automated control systems, and other types of systems. A WLAN sensing system (which may be referred to as a Wi-Fi sensing system) is one recent addition to motion detection systems. A Wi-Fi sensing system may be a network of Wi-Fi-enabled devices that may be a part of an IEEE 802.11 network. In an example, a Wi-Fi sensing system may be configured to detect features of interest in a sensing space. A sensing space may refer to any physical space in which the Wi-Fi sensing system may operate, such as a place of residence, a place of work, a shopping mall, a sports hall or sports stadium, a garden, or any other physical space. Features of interest may include motion of objects and motion tracking, presence detection, intrusion detection, gesture recognition, fall detection, breathing rate detection, and other applications.

A typical Wi-Fi sensing system includes a sensing transmitter (which may be an access point (AP) or a non-AP station (STA)) and a sensing receiver (which is an AP if the sensing transmitter is a STA, and a STA if the sensing transmitter is an AP). A sensing transmission is sent from the sensing transmitter to the sensing receiver. The sensing measurement is made using the sensing transmission at the sensing receiver.

### BRIEF SUMMARY OF THE DISCLOSURE

The present disclosure generally relates to systems and methods for Wi-Fi sensing. In particular, the present disclosure relates to systems and methods for Wi-Fi network evaluation.

Methods are provided for Wi-Fi network evaluation. In an example embodiment, a method for Wi-Fi network evaluation is described. The method may be carried out by a networking device operating within a Wi-Fi network including a plurality of stations and a plurality of access points. The networking device includes at least one processor configured to execute instructions. The method includes identifying a communication link topology of the Wi-Fi network, the communication link topology being defined by a plurality of communication links, each communication link being between an associated pair from the plurality of stations and the plurality of access points. In some embodiments, the method includes receiving a plurality of sensing measurements measured according to the communication link topology, and determining a proximity link topology of the Wi-Fi network based on the plurality of sensing measurements, the proximity link topology being defined by a plurality of proximity links, each proximity link being between a proximal network pair from a plurality of network pairs from the plurality of stations and the plurality of access points. Further, in some embodiments, the method includes identifying an overlap ratio based on the proximity link topology and the communication link topology, identifying a Wi-Fi network adjustment based on the overlap ratio.

In some embodiments, determining the proximity link topology includes identifying the proximal network pair as being between one of the plurality of stations and a corresponding one of the plurality of access points that is a closest access point to the one of the plurality of stations based on at least one of the plurality of sensing measurements.

In some embodiments, the at least one of the plurality of sensing measurements is indicative of a motion in a sensing space associated with the Wi-Fi network.

In some embodiments, identifying the proximal network pair further includes, in an analysis period including a plurality of motion detection windows that each includes a plurality of locating sampling instances, identifying, for the plurality of locating sampling instances, a corresponding plurality of network devices closest to the motion from the plurality of stations and the plurality of access points.

In some embodiments, identifying the proximal network pair further includes, for each motion detection window, identifying a plurality of network pairs, each network pair including one station and one access point from the plurality of network devices.

In some embodiments, identifying the proximal network pair further includes, for the analysis period, summing a number of occurrences of each of the plurality of network pairs.

In some embodiments, identifying the proximal network pair further includes, designating, as the proximal network pair, a selected one of the plurality of network pairs having a largest number of occurrences from among the plurality of network pairs that share a station.

In some embodiments, the motion is selected from a plurality of detected motions as the motion closest to one of the plurality of network devices.

In some embodiments, the method further includes, for a filtering window including the analysis period and a plurality of additional analysis periods, summing a number of occurrences of each of the plurality of network pairs in the filtering window.

In some embodiments, the method further includes, redesignating, as the proximal network pair, a new selected one of the plurality of network pairs having a largest number of occurrences from among the plurality of network pairs that share a station.

In some embodiments, the method further includes identifying an overlapping coverage area defined by selected ones of the plurality of stations having non-corresponding communication links and proximity links.

In some embodiments, the overlap ratio is defined as a ratio between a first number of selected ones of the plurality of stations having non-corresponding communication links and proximity links and a second number of the plurality of stations.

In some embodiments, identifying the Wi-Fi network adjustment is further based on the overlap ratio exceeding an overlap ratio threshold.

In some embodiments, the Wi-Fi network adjustment includes at least one of a frequency band change, a modulating coding scheme change, a transmission power reduction, a beamforming adjustment, and a network parameter change.

In some embodiments, the method further includes transmitting the Wi-Fi network adjustment to one or more selected access points from the plurality of access points.

In some embodiments, the method further includes determining a new overlap ratio subsequent to transmitting the Wi-Fi network adjustment.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system.

FIG. 2A and FIG. 2B are diagrams showing example wireless signals communicated between wireless communication devices.

FIG. 3A and FIG. 3B are plots showing examples of channel responses computed from the wireless signals communicated between wireless communication devices in FIG. 2A and FIG. 2B.

FIG. 4A and FIG. 4B are diagrams showing example channel responses associated with motion of an object in distinct regions of a space.

FIG. 4C and FIG. 4D are plots showing the example channel responses of FIG. 4A and FIG. 4B overlaid on an example channel response associated with no motion occurring in the space.

FIG. 5 depicts an implementation of some of an architecture of a system for Wi-Fi sensing, according to some embodiments.

FIG. 6 depicts an example of a WLAN sensing procedure, according to some embodiments.

FIG. 7A depicts an example of a Sensing Measurement Setup Request frame format, according to some embodiments.

FIG. 7B illustrates an example of a Sensing Measurement Parameters element, according to some embodiments.

FIG. 7C illustrates an example of a format of a Sensing Measurement Parameters field, according to some embodiments.

FIG. 7D depicts an example of a Sensing Measurement Setup Response frame, according to some embodiments.

FIG. 8A depicts one-to-many and many-to-one aspects of an example of a WLAN sensing procedure, according to some embodiments.

FIG. 8B depicts pairwise aspects of an example of a WLAN sensing procedure, according to some embodiments.

FIG. 9 depicts a message flow of a trigger-based (TB) sensing measurement instance of a WLAN sensing procedure that consists of either NDPA sounding or TF sounding, according to some embodiments.

FIG. 10A and FIG. 10B depict examples of trigger-based (TB) sensing measurement instances, according to some embodiments.

FIG. 11A and FIG. 11B depict an example of a single TB sensing measurement instance including a polling phase, a trigger frame sounding phase, and an NDPA sounding phase, according to some embodiments.

FIG. 12 depicts a message flow of a non-TB sensing measurement instance of a WLAN sensing procedure with both uplink and downlink sounding, according to some embodiments.

FIG. 13 depicts an example of a single non-TB sensing measurement instance, according to some embodiments.

FIG. 14 depicts an example of a Public Action frame format of a Sensing Measurement Report frame and a Sensing Measurement Report field format, according to some embodiments.

FIG. 15A to FIG. 15H depict a hierarchy of fields within a sensing trigger, according to some embodiments.

FIG. 16 depicts an example of a Wi-Fi sensing system including two access points connected via a backhaul link, according to some embodiments.

FIG. 17 depicts an example of a Wi-Fi network including communications links and proximity links, according to some embodiments.

FIG. 18 depicts an example of two motions in a same motion detection window period within a Wi-Fi network, according to some embodiments.

FIG. 19 depicts a cascaded filter system, according to some embodiments.

FIG. 20A and FIG. 20B depict a flowchart for performing Wi-Fi network evaluation to identify a Wi-Fi network adjustment, according to some embodiments.

FIG. 21A and FIG. 21B depict a flowchart for performing Wi-Fi network evaluation to identify a Wi-Fi network adjustment and transmit the Wi-Fi network adjustment to one or more selected access points, according to some embodiments.

FIG. 22A, FIG. 22B, and FIG. 22C depict a flowchart for performing Wi-Fi network evaluation to identify a Wi-Fi network adjustment, according to some embodiments.

### DETAILED DESCRIPTION

Wireless sensing enables a device to obtain sensing measurements of transmission channel(s) between two or more devices. With the execution of a wireless sensing procedure, it is possible for a device to obtain sensing measurements useful for detecting and tracking changes in the environment. In some aspects of what is described herein, a wireless sensing system may be used for a variety of wireless sensing applications by processing wireless signals (e.g., radio frequency (RF) signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access point (AP) assumes the receiver role, and each Wi-Fi device (station (STA), node, or peer) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information, etc.) provided by a beamforming system. Beamforming is a signal processing technique often used in multi antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a sensing transmitter, sensing receiver, or sensing initiator communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered or caused to make sensing transmissions or sensing measurements less frequently. In some implementations, when motion is present, for example, the wireless sensing system can increase the triggering rate or sensing transmissions rate or sensing measurement rate to produce a time-series of measurements with finer time resolution. Controlling a variable sensing measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or extended service set (ESS) topology, multiple coordinating wireless APs each provide a basic service set (BSS) which may occupy different frequency bands and allow devices to transparently move between from one participating AP to another (e.g., mesh). For instance, within a home mesh network, Wi-Fi devices can connect to any of the APs, but typically select one with good signal strength. The coverage footprints of the mesh APs typically overlap, often putting each device within communication range or more than one AP. If the AP supports multi-bands (e.g., 2.4 GHz and 5 GHZ), the wireless sensing system may keep a device connected to the same physical AP but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area to improve detection coverage, or to better localize motion within an area.

In some cases, beamforming may be performed between wireless communication devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. Thus, changes to the steering or feedback properties used in the beamforming process indicate changes, which may be caused by moving objects, in the space accessed by the wireless communication system. For example, motion may be detected by substantial changes in the communication channel, e.g., as indicated by a channel response, or steering or feedback properties, or any combination thereof, over a period of time.

In some implementations, for example, a steering matrix may be generated at a transmitter device (beamformer) based on a feedback matrix provided by a receiver device (beamformee) based on channel sounding. Because the steering and feedback matrices are related to propagation characteristics of the channel, these matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, many beamforming matrices (e.g., feedback matrices or steering matrices) may be generated to represent a multitude of directions that an object may be located relative to a wireless communication device. These many beamforming matrices may be used to generate the spatial map. The spatial map may be used to detect the presence of motion in the space or to detect a location of the detected motion.

In some instances, a motion detection system can control a variable device measurement rate in a motion detection process. For example, a feedback control system for a multi-node wireless motion detection system may adaptively change the sample rate based on environmental conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the description are provided below.

A wireless access point (WAP) or simply an access point (AP) is a networking device in a WLAN network that allows other networking devices in a WLAN network to connect to a wired network. In examples, an AP creates a wireless local area network.

A station (STA) is any device that is connected to a WLAN network, and which contains 802.11 compliant MAC and PHY interfaces to the wireless medium. A STA may be a laptop, desktop, smartphone, or a smart appliance. A STA may be fixed, mobile or portable. A STA that does not take on the roles of an AP may be referred to as a non-AP STA.

A term “transmission opportunity (TXOP)” may refer to a negotiated interval of time during which a particular quality of service (QoS) station (e.g., a STA, an AP, or either a STA or an AP, for example in the role of a sensing initiator, a sensing responder, a sensing transmitter or a sensing receiver) may have the right to initiate a frame exchange onto a wireless medium. A QoS access category (AC) of the transmission opportunity may be requested as part of a service or session negotiation.

A term “Quality of Service (QoS) access category (AC)” may refer to an identifier for a frame which classifies a priority of transmission that the frame requires. In an example, four QoS access categories are defined namely AC_VI: Video, AC_VO: Voice, AC_BE: Best-Effort, and AC_BK: Background. Further, each QoS access category may have different TXOP parameters defined for it.

A term “short interframe space (SIFS)” may refer to a period within which a processing element (for example, a microprocessor, dedicated hardware, or any such element) within a device of a Wi-Fi sensing system is able to process data presented to it in a frame. In an example, a short interframe space may be 10 ms.

A term “PHY-layer Protocol Data Unit (PPDU)” may refer to a data unit that includes preamble and data fields. The preamble field may include transmission vector format information and the data field may include payload and higher layer headers.

A term “null data PPDU (NDP)” may refer to a PPDU that does not include a data field. In an example, a null data PPDU may be used for a sensing transmission, where a MAC header of the NDP includes information required for a sensing receiver to make a sensing measurement on the sensing transmission.

A term “transmission parameters” may refer to a set of IEEE 802.11 PHY transmitter configuration parameters which are defined as a part of transmission vector (TXVECTOR) corresponding to a specific PHY and which may be configurable for each PHY-layer PPDU transmission or each null data PPDU (NDP) transmission.

A term “resource unit (RU)” may refer to an allocation of orthogonal frequency division multiplexing (OFDM) channels which may be used to carry a modulated signal. An RU may include a variable number of carriers depending on the mode of the modem.

A term “tone” may refer to an individual subcarrier in an OFDM signal. A tone may be represented in time domain or frequency domain. In time domain, a tone may also be referred to as a symbol. In frequency domain, a tone may also be referred to as a subcarrier.

A term “sensing goal” may refer to a goal of a sensing activity at a time. A sensing goal is not static and may change at any time. In an example, a sensing goal may require sensing measurements of a specific type, a specific format, or a specific precision, resolution, or accuracy to be available to a sensing algorithm.

A term “sensing space” may refer to any physical space in which a Wi-Fi sensing system may operate.

A term “wireless local area network (WLAN) sensing session” or “Wi-Fi sensing session” may refer to a period during which objects in a physical space may be probed, detected and/or characterized. In an example, during a WLAN sensing session, several devices participate in, and thereby contribute to the generation of sensing measurements. A WLAN sensing session may be referred to as a “measurement campaign.”

A term “non-sensing message” may refer to a message which is not primarily related to sensing. In an example, non-sensing messages may include data, management, and control messages.

A term “sensing measurement” may refer to a measurement of a state of a wireless channel between a transmitter device (for example, a sensing transmitter) and a receiver device (for example, a sensing receiver) derived from a sensing transmission. In an example, sensing measurement may also be referred to as channel response measurement.

A term “sensing algorithm” may refer to a computational algorithm that achieves a sensing goal. A sensing algorithm may be executed on any device in a Wi-Fi sensing system.

Wireless network management (WNM) may provide information on network conditions and may also provide a means to obtain and exchange WLAN sensing information.

A sensing receiver is a station (STA) that receives sensing transmissions (for example, PPDUs or any other transmission including a data transmission which may be opportunistically used as a sensing transmission) sent by a sensing transmitter and performs sensing measurements as part of a WLAN sensing procedure. An AP is an example of a sensing receiver. In some examples, a STA may also be a sensing receiver.

A sensing transmitter is a station (STA) that transmits a sensing transmission (for example, PPDUs or any other transmission) used for sensing measurements (for example, channel state information) in a WLAN sensing procedure. In an example, a STA is an example of a sensing transmitter. In some examples, an AP may be a sensing transmitter for Wi-Fi sensing purposes, for example where a STA acts as a sensing receiver.

A sensing initiator is a station (STA) that initiates a WLAN sensing procedure. The role of sensing initiator may be taken on by a sensing receiver, a sensing transmitter, or a separate device which includes a sensing algorithm (for example, a remote processing device).

A sensing responder is a station (STA) that participates in a WLAN sensing procedure initiated by a sensing initiator. The role of sensing responder may be taken on by a sensing receiver or a sensing transmitter. In examples, multiple sensing responders may take part in a Wi-Fi sensing session.

A sensing by proxy (SBP) initiator is defined as a non-AP STA acting as a sensing initiator that transmits a SBP Request frame. In examples, sensing by proxy (SBP) enables a non-AP STA to obtain sensing measurements of the channel between an AP and one or more non-AP STAs or between a receive antenna and a transmit antenna of an AP. With the execution of the SBP procedure, it is possible for a non-AP STA to obtain sensing measurements necessary for detecting and tracking changes in the environment. A sensing by proxy (SBP) responder is an AP that receives or is the intended recipient of an SBP Request frame.

A term “sensing transmission” may refer to a transmission made from a sensing transmitter to a sensing receiver which may be used to make a sensing measurement. In an example, a sensing transmission may also be referred to as wireless sensing signal or wireless signal.

A term “sensing trigger message” may refer to a message sent from a sensing initiator to a sensing transmitter to initiate or trigger one or more sensing transmissions.

A term “sensing response message” may refer to a message which is included within a sensing transmission from a sensing transmitter to a sensing receiver. A sensing transmission that includes a sensing response message may be used by a sensing receiver to perform a sensing measurement.

A term “sensing response announcement” may refer to a message that is included within a sensing transmission from a sensing transmitter to a sensing receiver that announces that a sensing response NDP will follow within a short interframe space (SIFS). An example of a sensing response announcement is an NDP announcement, or NDPA. In examples, a sensing response NDP may be transmitted using a requested transmission configuration.

A term “sensing response NDP” may refer to a response transmitted by a sensing transmitter and used for a sensing measurement at a sensing receiver. In examples, a sensing response NDP may be used when a requested transmission configuration is incompatible with transmission parameters required for successful non-sensing message reception. A sensing response NDP may be announced by a sensing response announcement. In an example, a sensing response NDP may be implemented with a null data PPDU. In some examples, a sensing response NDP may be implemented with a frame that does not contain any data.

A term “channel representation information (CRI)” may refer to properties of a communications channel, such as how wireless signals propagate from a sensing transmitter to a sensing receiver along multiple paths, that are known or measured by a technique of channel estimation. For example, CRI may refer to one or more sensing measurements made on one or more sensing transmissions during a sampling instance which together represent the state of the channel at the sampling instance between two devices.

A term “channel state information (CSI)” may refer to an example of CRI which is represented in a frequency domain. CSI is typically a matrix of complex values representing the amplitude attenuation and phase shift of signals, or in-phase and quadrature components of signals, which provide an estimation of a communications channel.

A term “time-domain channel representation information (TD-CRI)” may refer to an example of CRI which is represented in a time domain. TD-CRI may be generated by applying an inverse transform, such as an IDFT or an IFFT, to CSI.

A term “feature of interest” may refer to an item or state of an item in a sensing space which is positively detected and/or identified by a sensing algorithm.

A term “requested transmission configuration” may refer to transmission parameters a sensing transmitter is requested to use when sending a sensing transmission.

A term “delivered transmission configuration” may refer to transmission parameters applied by a sensing transmitter to a sensing transmission.

A term “steering matrix configuration” may refer to a matrix of complex values representing real and complex phase required to pre-condition one or more antenna of a radio frequency (RF) transmission signal chain for each transmit signal. Application of a steering matrix configuration (for example, by a spatial mapper) enables beamforming and beam-steering.

A term “spatial mapper” may refer to a signal processing element that adjusts the amplitude and phase of a signal input to an RF transmission chain in a sensing transmitter. A spatial mapper may include elements to process the signal to each RF chain implemented. The operation carried out may be called spatial mapping. The output of a spatial mapper is one or more spatial streams.

A term “network pair” may refer to one of all the possible station-access point pairs in a Wi-Fi network. A network pair is formed of two devices in the network, one of which performs the function of the access point and one of which performs the function of the non-AP station. An access point may be in more than one network pair.

A term “proximity link” may refer to a virtual link between a station and an access point that may be used to indicate the physically closest access point to the station.

A term “proximal network pair” may refer to a network pair with a proximity link.

A “localizer” may be a function of a sensing agent, which can determine the closest station or access point to a motion.

A “physical network determination agent” may be a part of a sensing agent and may be used to determine the physical proximity of access points and stations in a Wi-Fi network based on information from locating sampling instances determined by a localizer.

A “Wi-Fi network coordination agent” may be an agent at a higher level than the level of an access point in a Wi-Fi network. The main function of the Wi-Fi network coordination agent may be to coordinate with all the access points in a sensing space, and store and process the information from a localizer or a physical network determination agent or other Wi-Fi network elements or other Wi-Fi network agents.

A term “locating sampling instance” may refer to as an instance (or a small period of time) during which a localizer samples (or locates) a motion. A locating sampling instance may be noted as an “s”.

A term “motion detection window” may be defined as a time window that includes a number of locating sampling instances of a locating sampling series for a motion.

A term “analysis period” may be a period of time including multiple locating sampling instances for analysis purpose (for example, for sensing link analysis or proximity link analysis). In an example, an analysis period may be long, for example, covering an hour, a half day, a day, or longer.

A term “correct network pair” may be a network pair within which the station and the access point are both localized from a same single motion by a localizer.

A term “incorrect network pair” may be a network pair within which the station and the access point are localized from different motions by a localizer.

A term “filtering window” may be a period of time long enough to mitigate incorrect network pairs. In examples, the filtering window may be equal in length or longer than an analysis period. In examples, the length of the filtering window may be an even multiple of the length of an analysis period.

A “network pair occurrence number” may be the number of sampling windows within which a network pair occurs over an analysis period or a filtering window.

A “cascaded filter system” may be a system that includes both an analysis period and a filtering window, and that balances the reduction in incorrect station-access point pair determinations and dynamics performance of its output.

A “simple filter system” may be a system that includes an analysis period and no filtering window or where the filtering window is configured to be equivalent to the analysis period.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a wireless sensing system configurated to send sensing transmissions and make sensing measurements.

Section C describes embodiments of systems and methods that are useful for Wi-Fi network evaluation.

### A. Wireless Communications System, Wireless Transmissions and Sensing Measurements

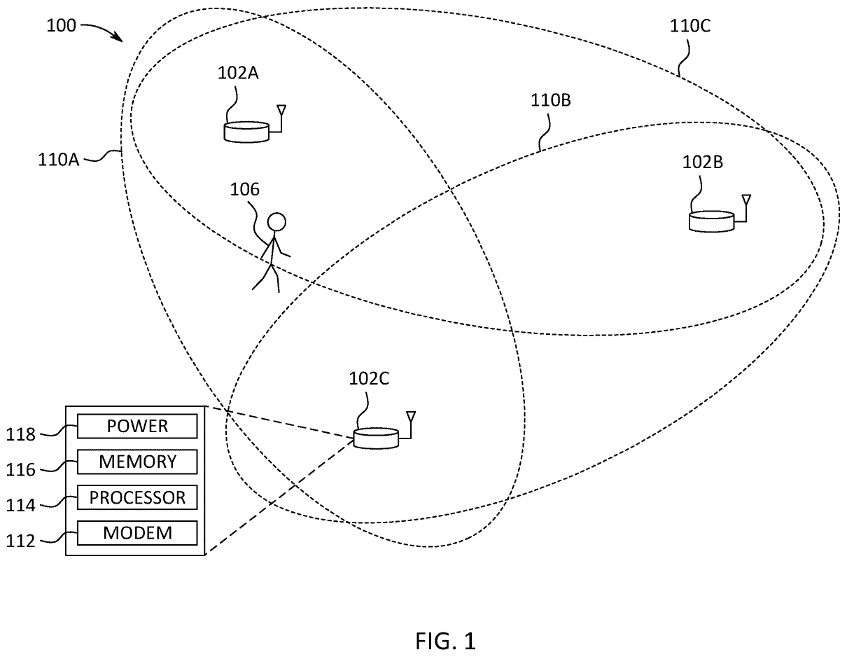

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a wireless local area network (WLAN), a personal area network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., Bluetooth®, Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as code division multiple access (CDMA), wideband code division multiple access (WCDMA), Universal Mobile Telecommunications System (UMTS), and time division synchronous code division multiple access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially available mesh network system (e.g., Plume Wi-Fi, Google Wi-Fi, Qualcomm Wi-Fi SON, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate RF signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and RF circuitry. The RF circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or may include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to RF signals, and wirelessly transmits the RF signals (e.g., through an antenna). In some instances, the radio subsystem in modem 112 wirelessly receives RF signals (e.g., through an antenna), down-converts the RF to baseband signals, and sends the baseband signals to the baseband subsystem. The signals exchanged between the radio subsystem and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes receives motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example processes herein disclosed.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an alternating current (AC) adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

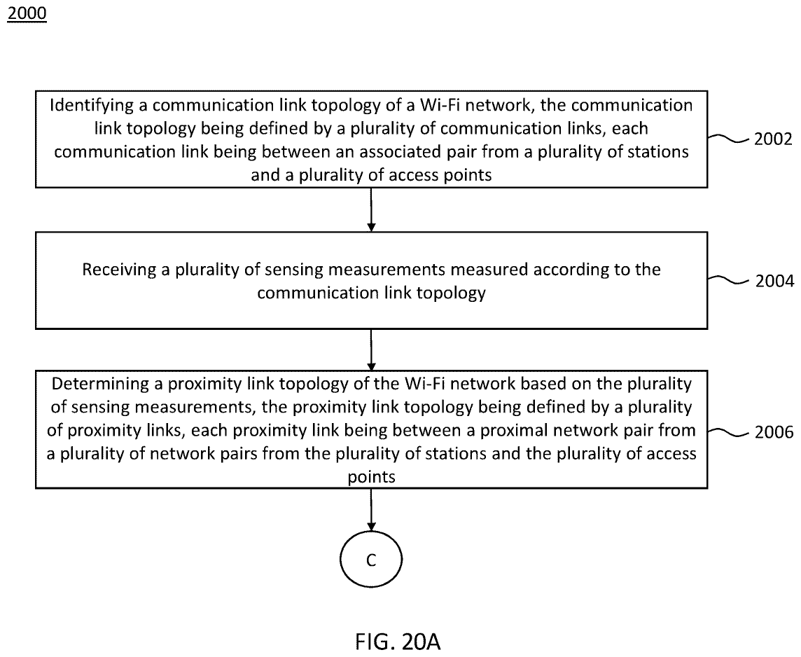

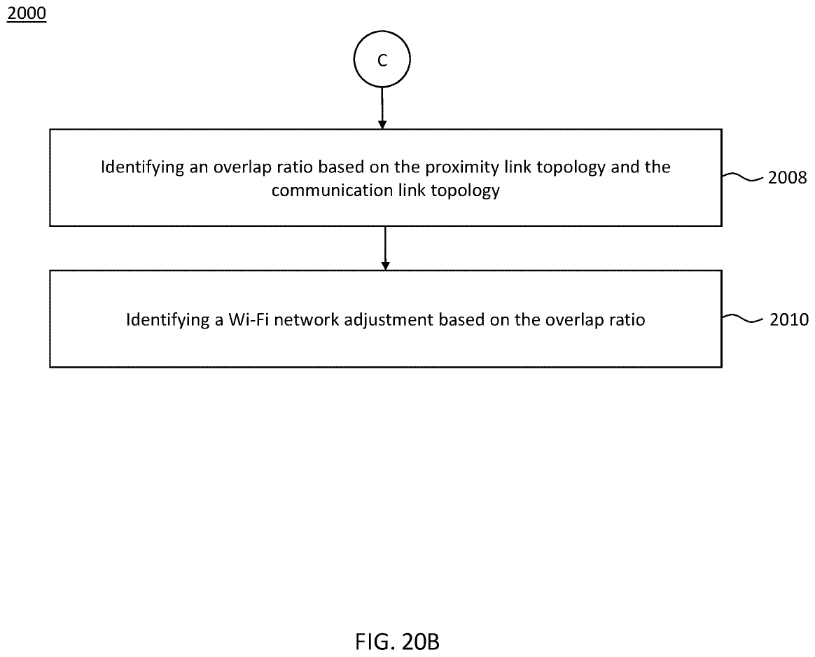

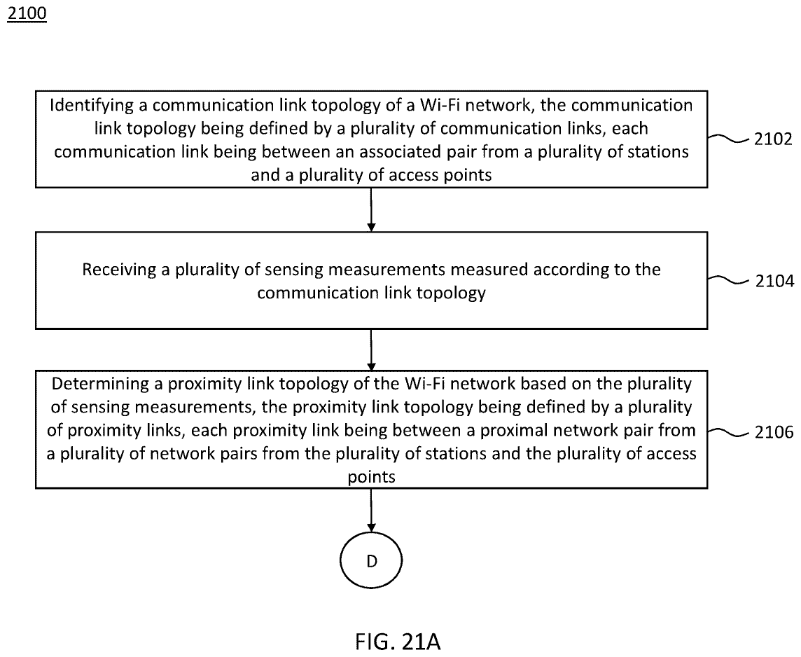

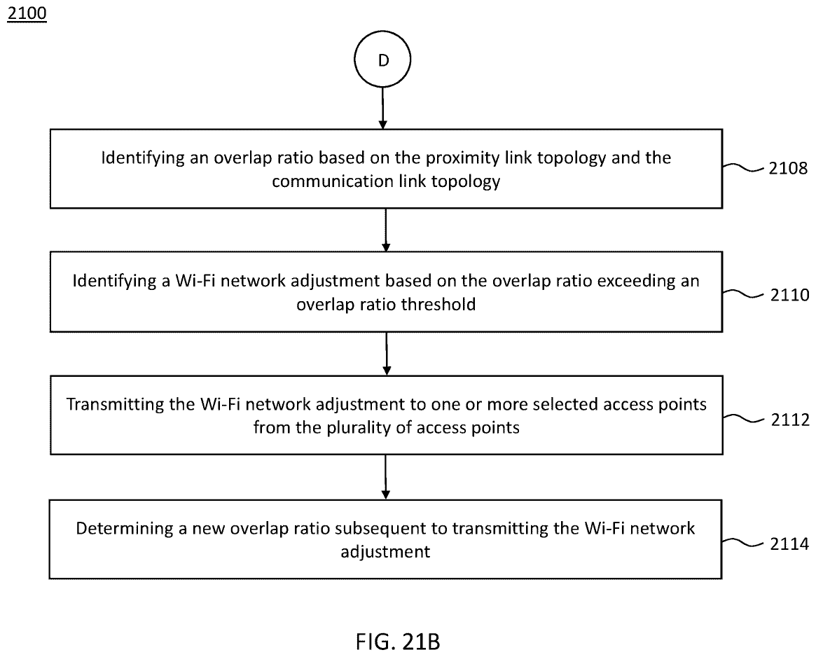

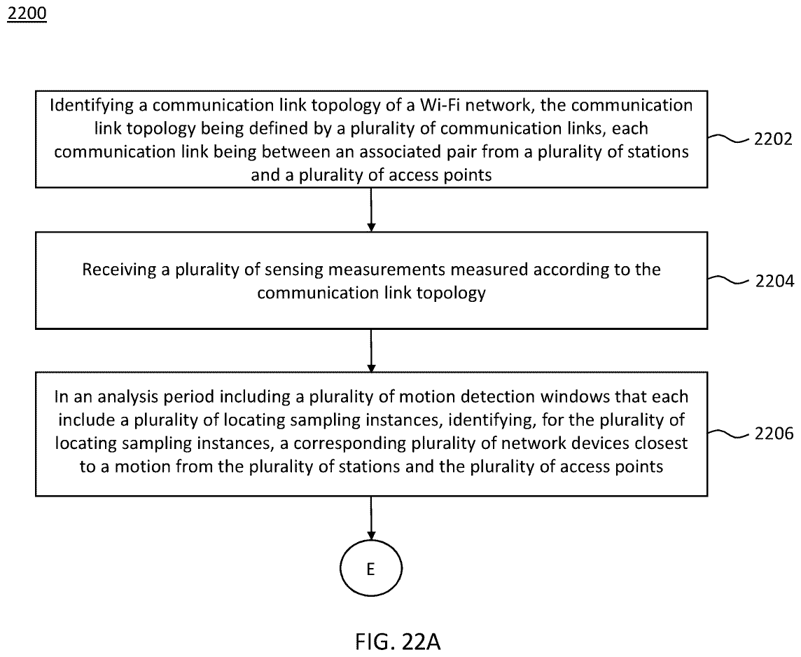

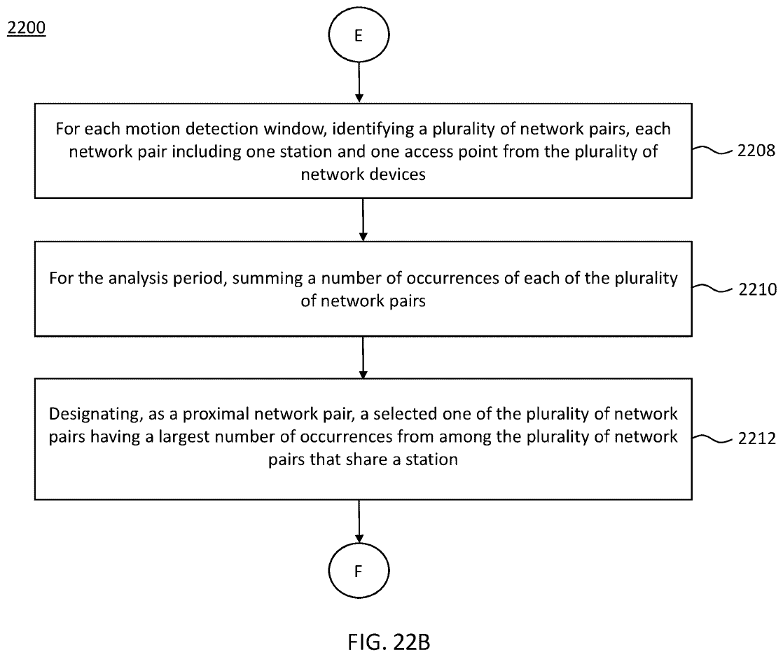

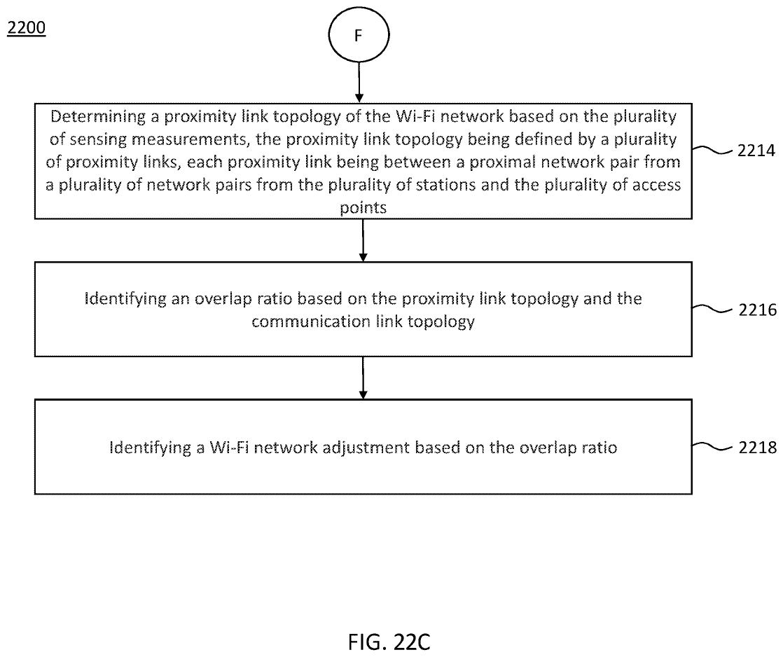

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to FIG. 20A, FIG. 20B, FIG. 21A, FIG. 21B, FIG. 22A, FIG. 22B, and FIG. 22C, or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

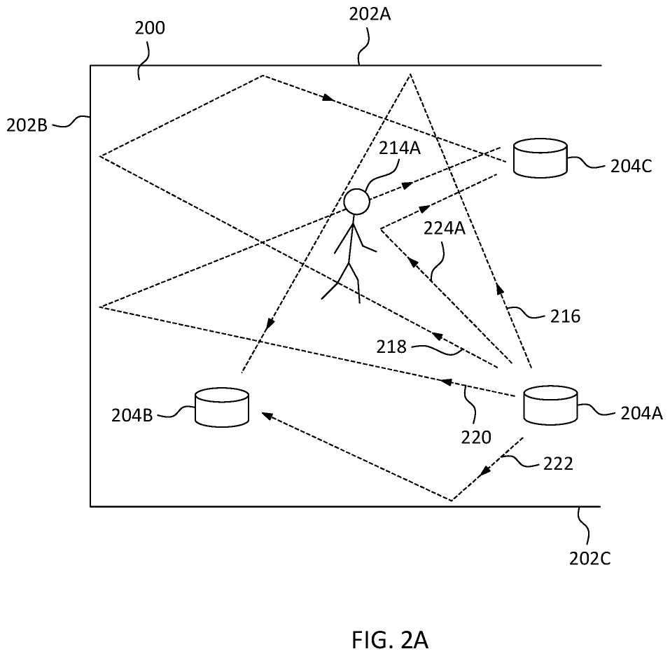

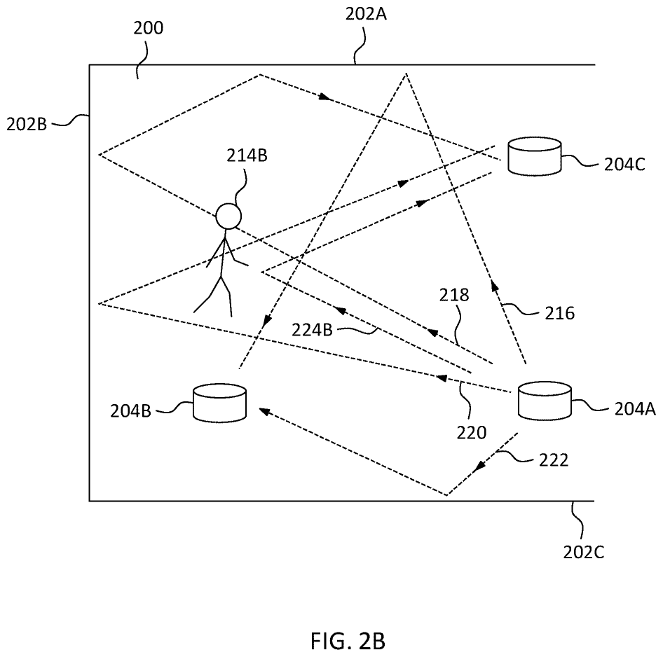

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. In an example, space 200 may be a sensing space. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f(t) transmitted from the first wireless communication device 204A may be described according to Equation (1):

$$f ( t ) = {\sum }_{n = - ∞}^{∞} {c}_{n} {e}^{j {ω}_{n}^{} t} \qquad ( 1 )$$

Where ωₙ represents the frequency of nth frequency component of the transmitted signal, cₙ represents the complex coefficient of the nth frequency component, and t represents time. With the f(t) being transmitted from the first wireless communication device 204A, an output signal rₖ(t) from a path, k, may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along k, and φ_{n,k} represents the phase of the signal for nth frequency component along k. Then, the received signal, R, at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

R at a wireless communication device can then be analyzed. R at a wireless communication device can be transformed to the frequency domain, for example, using a fast Fourier transform (FFT) or another type of algorithm. The transformed signal can represent R as a series of n complex values, one for each of the respective frequency components (at the n frequencies ωₙ). For a frequency component at frequency ωₙ, a complex value, Hₙ, may be represented as follows in Equation (5):

$${H}_{n} = {\sum }_{k} {c}_{n} {α}_{n , k} {e}^{j {ϕ}_{n , k}} \qquad ( 5 )$$

Hₙ for a given ωₙ indicates a relative magnitude and phase offset of the received signal at ωₙ. When an object moves in the space, Hₙ changes due to α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{c h} = {\sum }_{k} {\sum }_{n = - ∞}^{∞} {α}_{n , k} \qquad ( 6 )$$

In some instances, the channel response, h_{ch}, for a space can be determined, for example, based on the mathematical theory of estimation. For instance, a reference signal, Ref, can be modified with candidate h_{ch}, and then a maximum likelihood approach can be used to select the candidate channel which gives best match to the received signal (R_{cvd}). In some cases, an estimated received signal (\hat{R}_{cvd}) is obtained from the convolution of Ref with the candidate h_{ch}, and then the channel coefficients of h_{ch} are varied to minimize the squared error of \hat{R}_{cvd}. This can be mathematically illustrated as follows in Equation (7):

$${R}_{cvd} = {R}_{ef} ⊗ {h}_{ch} = {\sum }_{k = - 𝔪}^{m} {R}_{ef} ( n - k ) {h}_{c h} ( k ) \qquad ( 7 )$$

with the optimization criterion as in Equation (8):

$${min}_{{h}_{c h}} \{ \sum {( {\hat{R}}_{cvd} - {R}_{cvd} )}^{2} \} \qquad ( 8 )$$

The minimizing, or optimizing, process can utilize an adaptive filtering technique, such as least mean squares (LMS), recursive least squares (RLS), batch least squares (BLS), etc. The channel response can be a finite impulse response (FIR) filter, infinite impulse response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

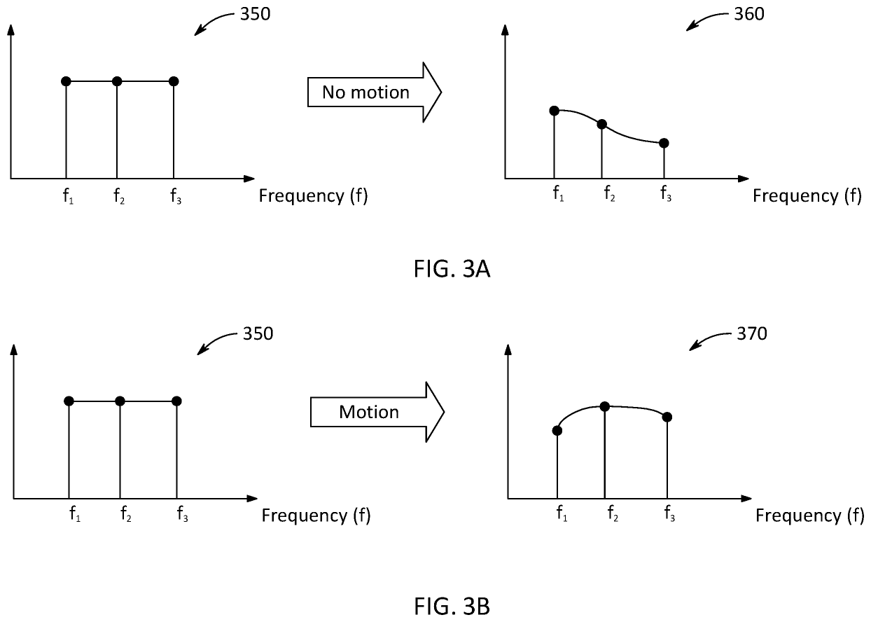

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component, f₁, f₂ and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

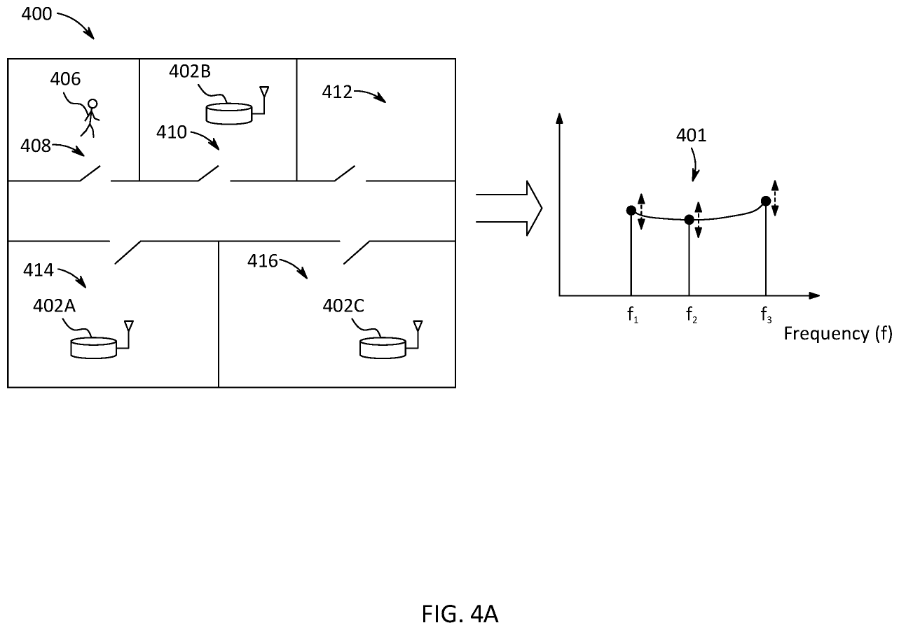

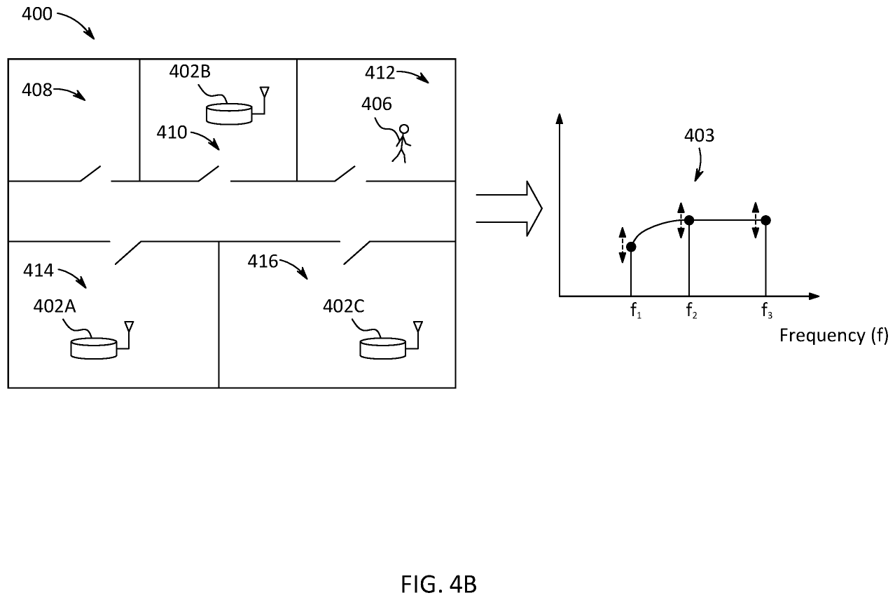

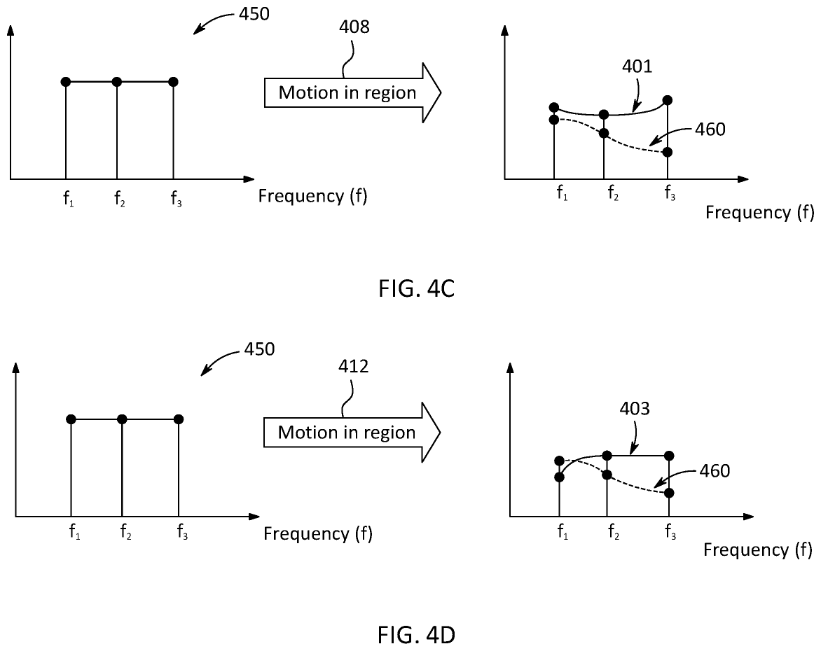

FIG. 4A and FIG. 4B are diagrams showing example channel responses 401, 403 associated with motion of object 406 in distinct regions 408, 412 of space 400. In the examples shown, space 400 is a building, and space 400 is divided into a plurality of distinct regions-first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of f₁, f₂ and f₃ is the same or nearly the same. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. In the example shown, wireless communication device 402 transmits a motion probe signal that has a flat frequency profile as shown in frequency domain representation 450. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained artificial intelligence (AI) model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each of f₁, f₂ and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component, f₂, is less than the outer frequency components f₁ and f₃), while channel response 403 has a convex-asymptotic frequency profile (the magnitude of the middle frequency component f₂ is greater than the outer frequency components, f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). Using this range of values, unique profiles (in examples profiles may also be referred to as signatures) may be identified for distinct regions within a space.

In some implementations, an AI model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier-based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentrations of values into separate clusters, while the second layer combines some of these clusters together to create a category for a distinct region. Additionally, subsequent layers can help in extending the distinct regions over more than two categories of clusters. For example, a fully connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a wireless sensing system configurated to send sensing transmissions and make sensing measurements.

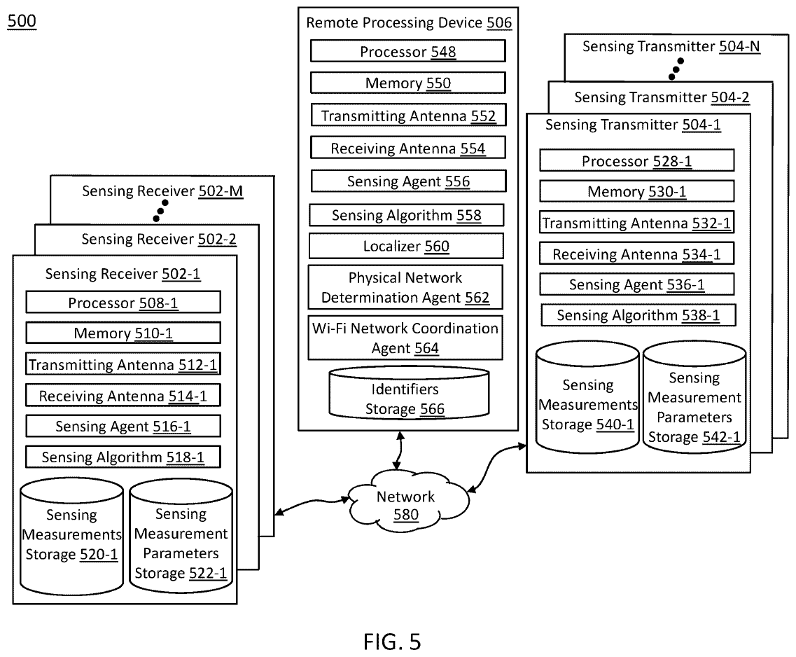

FIG. 5 depicts an implementation of some of an architecture of an implementation of system 500 for Wi-Fi sensing, according to some embodiments.

System 500 may include a plurality of networking devices. In an example, system 500 may include plurality of sensing receivers 502-(1-M), plurality of sensing transmitters 504-(1-N), remote processing device 506, and network 580 enabling communication between the system components for information exchange. In an example implementation, plurality of sensing transmitters 504-(1-N) may include at least first sensing transmitter 504-1 and second sensing transmitter 504-2. In an example implementation, plurality of sensing receivers 502-(1-M) may include at least first sensing receiver 502-1 and second sensing receiver 502-2. System 500 may be an example or instance of wireless communication system 100 and network 580 may be an example or instance of wireless network or cellular network, details of which are provided with reference to FIG. 1 and its accompanying description.

According to an embodiment, plurality of sensing receivers 502-(1-M) may be configured to receive one or more sensing transmissions (for example, from one or more of plurality of sensing transmitters 504-(1-N)) and perform one or more measurements (for example, channel representation information (CRI) measurements such as channel state information (CSI) or time domain channel representation information (TD-CRI)) useful for Wi-Fi sensing. In examples, these measurements may be known as sensing measurements. Sensing measurements may be processed to achieve a sensing goal of system 500. In an embodiment, one or more of plurality of sensing receivers 502-(1-M) may be an AP. In some embodiments, one or more of plurality of sensing receivers 502-(1-M) may take a role of sensing initiator and/or sensing responder.

According to an implementation, one or more of plurality of sensing receivers 502-(1-M) may be implemented by a device, such as wireless communication device 102 shown in FIG. 1. In some implementations, one or more of plurality of sensing receivers 502-(1-M) may be implemented by a device, such as wireless communication device 204 shown in FIG. 2A and FIG. 2B. Further, one or more of plurality of sensing receivers 502-(1-M) may be implemented by a device, such as wireless communication device 402 shown in FIG. 4A and FIG. 4B. In an implementation, one or more of plurality of sensing receivers 502-(1-M) may coordinate and control communication among plurality of sensing transmitters 504-(1-N). According to an implementation, one or more of plurality of sensing receivers 502-(1-M) may be enabled to control a sensing measurement session comprising one or more sensing measurement instances to ensure that required sensing transmissions are made at required times and to ensure an accurate determination of one or more sensing measurements. A sensing measurement instance may be referred to as a sensing measurement exchange. In some embodiments, one or more of plurality of sensing receivers 502-(1-M) may process sensing measurements to achieve the sensing goal of system 500. In some embodiments, one or more of plurality of sensing receivers 502-(1-M) may be configured to transmit sensing measurements to one or more of plurality of sensing transmitters 504-(1-N), and one or more of plurality of sensing transmitters 504-(1-N) may be configured to process the sensing measurements to achieve a sensing result of system 500.

In an embodiment, one or more of plurality of sensing receivers 502-(1-M) may be a STA. In an embodiment, one or more of plurality of sensing receivers 502-(1-M) may be an AP. In some embodiments, one or more of plurality of sensing receivers 502-(1-M) may be configured to transmit sensing measurements to remote processing device 506, and remote processing device 506 may be configured to process sensing measurements to achieve the sensing goal of system 500. In some embodiments, first sensing receiver 502-1 may be any computing device, such as a desktop computer, a laptop, a tablet computer, a mobile device, a personal digital assistant (PDA), or any other computing device.

Referring again to FIG. 5, in some embodiments, one or more of plurality of sensing transmitters 504-(1-N) may be configured to send one or more sensing transmissions to one or more of plurality of sensing receivers 502-(1-M) based on which one or more sensing measurements may be performed for Wi-Fi sensing. In an embodiment, one or more of plurality of sensing transmitters 504-(1-N) may be a STA. In an embodiment, one or more of plurality of sensing transmitters 504-(1-N) may be an AP. In some embodiments, one or more of plurality of sensing transmitters 504-(1-N) may take a role of sensing initiator and/or sensing responder.

According to an implementation, one or more of plurality of sensing transmitters 504-(1-N) may be implemented by a device, such as wireless communication device 102 shown in FIG. 1. In some implementations, one or more of plurality of sensing transmitters 504-(1-N) may be implemented by a device, such as wireless communication device 204 shown in FIG. 2A and FIG. 2B. Further, one or more of plurality of sensing transmitters 504-(1-N) may be implemented by a device, such as wireless communication device 402 shown in FIG. 4A and FIG. 4B. In some embodiments, first sensing transmitter 504-1 may be any computing device, such as a desktop computer, a laptop, a tablet computer, a mobile device, a PDA, or any other computing device. In some implementations, communication between one or more of plurality of sensing receivers 502-(1-M) and one or more of plurality of sensing transmitters 504-(1-N) may happen via station management entity (SME) and MAC layer management entity (MLME) protocols.

In some embodiments, remote processing device 506 may be configured to receive sensing measurements from one or more of plurality of sensing receivers 502-(1-M) and process the sensing measurements. In an example, remote processing device 506 may process and analyze sensing measurements to identify one or more features of interest. According to some implementations, remote processing device 506 may include/execute a sensing algorithm. In an embodiment, remote processing device 506 may be a STA. In some embodiments, remote processing device 506 may be an AP. According to an implementation, remote processing device 506 may be implemented by a device, such as wireless communication device 102 shown in FIG. 1. In some implementations, remote processing device 506 may be implemented by a device, such as wireless communication device 204 shown in FIG. 2A and FIG. 2B. Further, remote processing device 506 may be implemented by a device, such as wireless communication device 402 shown in FIG. 4A and FIG. 4B. In some embodiments, remote processing device 506 may be any computing device, such as a desktop computer, a laptop, a tablet computer, a mobile device, a personal digital assistant (PDA) or any other computing device. In embodiments, remote processing device 506 may take a role of sensing initiator where a sensing algorithm determines a Wi-Fi sensing session and the sensing measurements required to fulfill the measurement campaign. In an example, remote processing device 506 may communicate sensing measurement parameters and/or transmission parameters required to initiate a Wi-Fi sensing session to one or more of plurality of sensing receivers 502-(1-M) and/or to one or more of plurality of sensing transmitters 504-(1-N) to coordinate and control sensing transmissions for performing sensing measurements.

Referring to FIG. 5 in more detail, sensing receiver 502-1 (which is an example of one or more of plurality of sensing receivers 502-(1-M)) may include processor 508-1 and memory 510-1. For example, processor 508-1 and memory 510-1 of sensing receiver 502-1 may be processor 114 and memory 116, respectively, as shown in FIG. 1. In an embodiment, sensing receiver 502-1 may further include transmitting antenna(s) 512-1, receiving antenna(s) 514-1, and sensing agent 516-1. In some embodiments, an antenna may be used to both transmit and receive signals in a half-duplex format. When the antenna is transmitting, it may be referred to as transmitting antenna 512-1, and when the antenna is receiving, it may be referred to as receiving antenna 514-1. It is understood by a person of normal skill in the art that the same antenna may be transmitting antenna 512-1 in some instances and receiving antenna 514-1 in other instances. In the case of an antenna array, one or more antenna elements may be used to transmit or receive a signal, for example, in a beamforming environment. In some examples, a group of antenna elements used to transmit a composite signal may be referred to as transmitting antenna 512-1, and a group of antenna elements used to receive a composite signal may be referred to as receiving antenna 514-1. In some examples, each antenna is equipped with its own transmission and receive paths, which may be alternately switched to connect to the antenna depending on whether the antenna is operating as transmitting antenna 512-1 or receiving antenna 514-1.

In an implementation, sensing agent 516-1 may be responsible for causing sensing receiver 502-1 to receive sensing transmissions and associated sensing measurement parameters and/or transmission parameters, to calculate sensing measurements. In examples, sensing agent 516-1 may be responsible for processing sensing measurements to fulfill a sensing goal. In some implementations, receiving sensing transmissions and optionally associated sensing measurement parameters and/or transmission parameters, and calculating sensing measurements may be carried out by sensing agent 516-1 running in the medium access control (MAC) layer of sensing receiver 502-1 and processing sensing measurements to fulfill a sensing goal may be carried out by an algorithm running in the application layer of sensing receiver 502-1, for example sensing algorithm 518-1. In examples, a sensing algorithm 518-1 running in the application layer of sensing receiver 502-1 may be known as a Wi-Fi sensing agent, a sensing application, or sensing algorithm. In examples, sensing algorithm 518-1 may include and/or execute sensing agent 516-1. According to some implementations, sensing agent 516-1 may include and/or execute sensing algorithm 518-1. In some implementations, sensing agent 516-1 running in the MAC layer of sensing receiver 502-1 and sensing algorithm 518-1 running in the application layer of sensing receiver 502-1 may run separately on processor 508-1. In an implementation, sensing agent 516-1 may pass one or more of sensing measurement parameters, transmission parameters, or physical layer parameters (e.g., such as channel representation information, examples of which are CSI and TD-CRI) between the MAC layer of sensing receiver 502-1 and the application layer of sensing receiver 502-1. In an example, sensing agent 516-1 in the MAC layer or sensing algorithm 518-1 in the application layer may operate on physical layer parameters, for example, to detect one or more features of interest. In examples, sensing algorithm 518-1 may form services or features, which may be presented to an end-user. According to an implementation, communication between the MAC layer of sensing receiver 502-1 and other layers or components of sensing receiver 502-1 (including the application layer) may take place based on communication interfaces, such as an MLME interface and a data interface. In examples, sensing agent 516-1 may be configured to determine a number and timing of sensing transmissions and sensing measurements for the purpose of Wi-Fi sensing. In some implementations, sensing agent 516-1 may be configured to transmit sensing measurements to plurality of sensing transmitters 504-(1-N) and/or remote processing device 506 for further processing. In an implementation, sensing agent 516-1 may be configured to cause at least one transmitting antenna of transmitting antenna(s) 512-1 to transmit messages to one or more of plurality of sensing transmitters 504-(1-N) or to remote processing device 506. Further, sensing agent 516-1 may be configured to receive, via at least one receiving antenna of receiving antennas(s) 514-1, messages from one or more of plurality of sensing transmitters 504-(1-N) or from remote processing device 506. In an example, sensing agent 516-1 may be configured to make sensing measurements based on sensing transmissions received from one or more of plurality of sensing transmitters 504-(1-N).

In some embodiments, sensing receiver 502-1 may include sensing measurements storage 520-1. In an implementation, sensing measurements storage 520-1 may store sensing measurements computed by sensing receiver 502-1 based on received sensing transmissions. In an example, sensing measurements stored in sensing measurements storage 520-1 may be periodically or dynamically updated as required. In some embodiments, sensing receiver 502-1 may include sensing measurement parameters storage 522-1. In an implementation, sensing measurement parameters storage 522-1 may store sensing measurement parameters and/or transmission parameters applicable to one or more sensing measurement setups. In an implementation, sensing measurement parameters storage 522-1 may store sensing measurement parameters and/or transmission parameters applicable to one or more sensing measurement sessions. In an implementation, sensing measurement parameters storage 522-1 may store sensing measurement parameters and/or transmission parameters applicable to one or more sensing measurement instances. In an example, sensing measurement parameters and/or transmission parameters stored in sensing measurement parameters storage 522-1 may be periodically or dynamically updated as required. In an implementation, sensing measurements storage 520-1 and sensing measurement parameters storage 522-1 may include any type or form of storage, such as a database or a file system or coupled to memory 510-1.

Referring again to FIG. 5, sensing transmitter 504-1 (which is an example of one or more of plurality of sensing transmitters 504-(1-N)) may include processor 528-1 and memory 530-1. For example, processor 528-1 and memory 530-1 of sensing transmitter 504-1 may be processor 114 and memory 116, respectively, as shown in FIG. 1. In an embodiment, sensing transmitter 504-1 may further include transmitting antenna(s) 532-1, receiving antenna(s) 534-1, and sensing agent 536-1.

Sensing agent 536-1 may be configured to cause at least one transmitting antenna of transmitting antenna(s) 532-1 and at least one receiving antenna of receiving antennas(s) 534-1 to exchange messages with one or more of plurality of sensing receivers 502-(1-M)) or with remote processing device 506. In some embodiments, an antenna may be used to both transmit and receive in a half-duplex format. When the antenna is transmitting, it may be referred to as transmitting antenna 532-1, and when the antenna is receiving, it may be referred to as receiving antenna 534-1. It is understood by a person of normal skill in the art that the same antenna may be transmitting antenna 532-1 in some instances and receiving antenna 534-1 in other instances. In the case of an antenna array, one or more antenna elements may be used to transmit or receive a signal, for example, in a beamforming environment. In some examples, a group of antenna elements used to transmit a composite signal may be referred to as transmitting antenna 532-1, and a group of antenna elements used to receive a composite signal may be referred to as receiving antenna 534-1. In some examples, each antenna is equipped with its own transmission and receive paths, which may be alternately switched to connect to the antenna depending on whether the antenna is operating as transmitting antenna 532-1 or receiving antenna 534-1.

In an implementation, sensing agent 536-1 may be responsible for causing sensing transmitter 504-1 to send sensing transmissions and, in examples, receive associated sensing measurements from one or more of plurality of sensing receivers 502-(1-M). In examples, sensing agent 536-1 may be responsible for processing sensing measurements to fulfill a sensing goal. In some implementations, sensing agent 536-1 may run in the medium access control (MAC) layer of sensing transmitter 504-1, and processing sensing measurements to fulfill a sensing goal may be carried out by sensing algorithm 538-1, which in examples may run in the application layer of sensing transmitter 504-1. In examples, sensing algorithm 538-1 running in the application layer of sensing transmitter 504-1 may be known as a Wi-Fi sensing agent, a sensing application, or a sensing algorithm. In examples, sensing algorithm 538-1 may include and/or execute sensing agent 536-1. According to some implementations, sensing agent 536-1 may include and/or execute sensing algorithm 538-1. In some implementations, sensing agent 536-1 may run in the MAC layer of sensing transmitter 504-1 and sensing algorithm 538-1 may run in the application layer of sensing transmitter 504-1. In some implementations, sensing agent 536-1 of sensing transmitter 504-1 and sensing algorithm 538-1 may run separately on processor 528-1. In an implementation, sensing agent 536-1 may pass sensing measurement parameters, transmission parameters, or physical layer parameters between the MAC layer of sensing transmitter 504-1 and the application layer of sensing transmitter 504-1. In an example, sensing agent 536-1 in the MAC layer or sensing algorithm 538-1 in the application layer may control physical layer parameters, for example physical layer parameters used to generate one or more sensing transmissions. In examples, sensing algorithm 538-1 may form services or features, which may be presented to an end-user. According to an implementation, communication between the MAC layer of sensing transmitter 504-1 and other layers or components of sensing transmitter 504-1 (including the application layer) may take place based on communication interfaces, such as an MLME interface and a data interface. In examples, sensing agent 536-1 may be configured to determine a number and timing of sensing transmissions for the purpose of Wi-Fi sensing. In some implementations, sensing agent 536-1 may be configured to cause sensing transmitter 504-1 to transmit sensing transmissions to one or more of plurality of sensing receivers 502-(1-M). In an implementation, sensing agent 536-1 may be configured to cause at least one transmitting antenna of transmitting antenna(s) 532-1 to transmit messages to one or more of plurality of sensing receivers 502-(1-M) or to remote processing device 506. Further, sensing agent 536-1 may be configured to receive, via at least one receiving antenna of receiving antennas(s) 534-1, messages from one or more of plurality of sensing receivers 502-(1-M) or from remote processing device 506.

In some embodiments, sensing transmitter 504-1 may include sensing measurements storage 540-1. In an implementation, sensing measurements storage 540-1 may store sensing measurements computed by one or more of plurality of sensing receivers 502-(1-M) based on sensing transmissions sent by sensing transmitter 504-1 and sent by one or more of plurality of sensing receivers 502-(1-M) to sensing transmitter 504-1. In an example, sensing measurements stored in sensing measurements storage 540-1 may be periodically or dynamically updated as required. In an implementation, sensing measurements storage 540-1 may include any type or form of storage, such as a database or a file system or coupled to memory 530-1.

In some embodiments, sensing transmitter 504-1 may include sensing measurement parameters storage 542-1. In an implementation, sensing measurement parameters storage 542-1 may store sensing measurement parameters and/or transmission parameters applicable to one or more sensing measurement sessions. In an implementation, sensing measurement parameters storage 542-1 may store sensing measurement parameters and/or transmission parameters applicable to one or more sensing measurement setups. In an implementation, sensing measurement parameters storage 542-1 may store sensing measurement parameters and/or transmission parameters applicable to one or more sensing measurement instances. In an example, sensing measurement parameters and/or transmission parameters stored in sensing measurement parameters storage 542-1 may be periodically or dynamically updated as required. In an implementation, sensing measurements storage 540-1 and sensing measurement parameters storage 542-1 may include any type or form of storage, such as a database or a file system or coupled to memory 530-1.

Referring to FIG. 5 in more detail, remote processing device 506 may include processor 548 and memory 550. For example, processor 548 and memory 550 of remote processing device 506 may be processor 114 and memory 116, respectively, as shown in FIG. 1. In an embodiment, remote processing device 506 may further include transmitting antenna(s) 552, receiving antenna(s) 554, sensing agent 556, and sensing algorithm, 558. In some embodiments, an antenna may be used to both transmit and receive signals in a half-duplex format. When the antenna is transmitting, it may be referred to as transmitting antenna 552, and when the antenna is receiving, it may be referred to as receiving antenna 554. It is understood by a person of normal skill in the art that the same antenna may be transmitting antenna 552 in some instances and receiving antenna 554 in other instances. In the case of an antenna array, one or more antenna elements may be used to transmit or receive a signal, for example, in a beamforming environment. In some examples, a group of antenna elements used to transmit a composite signal may be referred to as transmitting antenna 552, and a group of antenna elements used to receive a composite signal may be referred to as receiving antenna 554. In some examples, each antenna is equipped with its own transmission and receive paths, which may be alternately switched to connect to the antenna depending on whether the antenna is operating as transmitting antenna 552 or receiving antenna 554.

In an implementation, sensing agent 556 may be responsible for determining sensing measurement parameters and/or transmission parameters for one or more sensing measurement setups. In examples, sensing agent 556 may receive sensing measurement parameters and/or transmission parameters for one or more sensing measurement setups from sensing algorithm 558. In an example, sensing agent 556 may receive sensing measurements from one or more of plurality of sensing receivers 502-(1-M) and may process the sensing measurements to fulfill a sensing goal. In an example, sensing agent 556 may receive channel representation information (such as CSI or TD-CRI) from one or more of plurality of sensing receivers 502-(1-M) and may process the channel representation information to fulfill a sensing goal. In implementations, sensing agent 556 may receive sensing measurements or channel representation information and may provide the received sensing measurements or channel representation information to sensing algorithm 558, and sensing algorithm 558 may receive the sensing measurements or channel representation information from sensing agent 556 and may process the information to fulfill a sensing goal.

In some implementations, receiving sensing measurements may be carried out by an algorithm running in the medium access control (MAC) layer of remote processing device 506 and processing sensing measurements to fulfill a sensing goal may be carried out by an algorithm running in the application layer of remote processing device 506. In examples, the algorithm running in the application layer of remote processing device 506 may be known as a Wi-Fi sensing agent, a sensing application, or sensing algorithm. In some implementations, the algorithm running in the MAC layer of remote processing device 506 and the algorithm running in the application layer of remote processing device 506 may run separately on processor 548. In an implementation, sensing agent 556 may pass physical layer parameters (e.g., such as channel representation information, examples of which are CSI and TD-CRI) from the MAC layer of remote processing device 506 to the application layer of remote processing device 506 and may use the physical layer parameters to detect one or more features of interest. In an example, the application layer may operate on the physical layer parameters and form services or features, which may be presented to an end-user. According to an implementation, communication between the MAC layer of remote processing device 506 and other layers or components of remote processing device 506 may take place based on communication interfaces, such as an MLME interface and a data interface. According to some implementations, sensing agent 556 may include/execute a sensing algorithm 558. In an implementation, sensing agent 556 may process and analyze sensing measurements using sensing algorithm 558 and identify one or more features of interest. Further, sensing agent 556 may be configured to determine a number and timing of sensing transmissions and sensing measurements for the purpose of Wi-Fi sensing. In some implementations, sensing agent 556 may be configured to cause one or more of plurality of sensing transmitters 504-(1-N) to transmit sensing measurements to one or more of plurality of sensing receivers 502-(1-M).

According to an implementation, remote processing device 506 may include localizer 560, physical network determination agent 562, and Wi-Fi network coordination agent 564. In an implementation, localizer 560, physical network determination agent 562, and Wi-Fi network coordination agent 564 may be coupled to processor 548 and memory 550. In some embodiments, localizer 560, physical network determination agent 562, and Wi-Fi network coordination agent 564 amongst other units, may include routines, programs, objects, components, data structures, etc., which may perform particular tasks or implement particular abstract data types. Localizer 560, physical network determination agent 562, and Wi-Fi network coordination agent 564 may also be implemented as, signal processor(s), state machine(s), logic circuitries, and/or any other device or component that manipulates signals based on operational instructions.

In some embodiments, localizer 560, physical network determination agent 562, and Wi-Fi network coordination agent 564 may be implemented in hardware, instructions executed by a processing unit, or by a combination thereof. The processing unit may comprise a computer, a processor, a state machine, a logic array or any other suitable devices capable of processing instructions. The processing unit may be a general-purpose processor that executes instructions to cause the general-purpose processor to perform the required tasks or, the processing unit may be dedicated to performing the required functions. In some embodiments, localizer 560, physical network determination agent 562, and Wi-Fi network coordination agent 564 may be machine-readable instructions that, when executed by a processor/processing unit, perform any of desired functionalities. The machine-readable instructions may be stored on an electronic memory device, hard disk, optical disk or other machine-readable storage medium or non-transitory medium. In an implementation, the machine-readable instructions may also be downloaded to the storage medium via a network connection. In an example, machine-readable instructions may be stored in memory 550.

According to some implementations, remote processing device 506 may include identifiers storage 566. In an implementation, identifiers storage 566 may store identifiers of one or more of plurality of sensing receivers 502-(1-M) and/or one or more of plurality of sensing transmitters 504-(1-N). In an example, identifiers of one or more of plurality of sensing receivers 502-(1-M) and/or one or more of plurality of sensing transmitters 504-(1-N) stored in identifiers storage 566 may be periodically or dynamically updated as required. In an implementation, identifiers storage 566 may include any type or form of storage, such as a database or a file system or coupled to memory 550.

Although, it has been described that localizer 560, physical network determination agent 562, Wi-Fi network coordination agent 564, and identifiers storage 566 are part of remote processing device 506, in some embodiments, localizer 560, physical network determination agent 562, Wi-Fi network coordination agent 564, and identifiers storage 566 may be part of one or more of plurality of sensing receivers 502-(1-M) and/or one or more of plurality of sensing transmitters 504-(1-N). Further, in some implementations, localizer 560, physical network determination agent 562, Wi-Fi network coordination agent 564, and identifiers storage 566 may be part of sensing agent 556.

For ease of explanation and understanding, descriptions provided above may be with reference to sensing receiver 502-1 or sensing transmitter 504-1, however, the description is equally applicable to one or more of plurality of sensing receivers 502-(1-M) and/or one or more of plurality of sensing transmitters 504-(1-N).

According to one or more implementations, communications in network 580 may be governed by one or more of the 802.11 family of standards developed by IEEE. Some example IEEE standards may include IEEE 802.11-2020, IEEE 802.11ax-2021, IEEE 802.11me, IEEE 802.11az and IEEE 802.11be. IEEE 802.11-2020 and IEEE 802.11ax-2021 are fully ratified standards whilst IEEE 802.11 me reflects an ongoing maintenance update to the IEEE 802.11-2020 standard and IEEE 802.11be defines the next generation of standard. IEEE 802.11az is an extension of the IEEE 802.11-2020 and IEEE 802.11ax-2021 standards which adds new functionality. In some implementations, communications may be governed by other standards (other or additional IEEE standards or other types of standards). In some embodiments, parts of network 580 which are not required by system 500 to be governed by one or more of the 802.11 family of standards may be implemented by an instance of any type of network, including wireless network or cellular network. Further, IEEE 802.11ax included OFDMA, which allows sensing receiver 502 to simultaneously transmit data to all participating devices, such as plurality of sensing transmitters 504-(1-N), and vice versa using a single transmission opportunity (TXOP). The efficiency of OFDMA depends on how sensing receiver 502 schedules channel resources (interchangeably referred to as RUs) among plurality of sensing transmitters 504-(1-N) and configures transmission parameters. According to an implementation, system 500 may be an OFDMA enabled system.

Referring back to FIG. 5, according to one or more implementations, system 500 for Wi-Fi sensing may participate in a sensing session. In examples, a sensing session is an agreement between a sensing initiator and a sensing responder to participate in a WLAN sensing procedure (also known as a Wi-Fi sensing procedure.) In examples, sensing measurement parameters associated with a sensing session may be determined by a sensing initiator and may be exchanged between the sensing initiator and a sensing responder. In examples, sensing initiator may be sensing transmitter 504-1 and sensing responder may be sensing receiver 502-1. In examples, sensing initiator may be sensing receiver 502-1 and sensing responder may be sensing transmitter 504-1. In examples, sensing initiator may be remote processing device 506, and both sensing transmitter 504-1 and sensing receiver 502-1 are sensing responders. In examples, sensing transmitter 504-1 may participate in multiple sensing sessions either as a sensing initiator or as a sensing responder. In examples, sensing receiver 502-1 may participate in multiple sensing sessions either as a sensing initiator or as a sensing responder. In examples, remote processing device may participate in multiple sensing sessions as a sensing initiator.

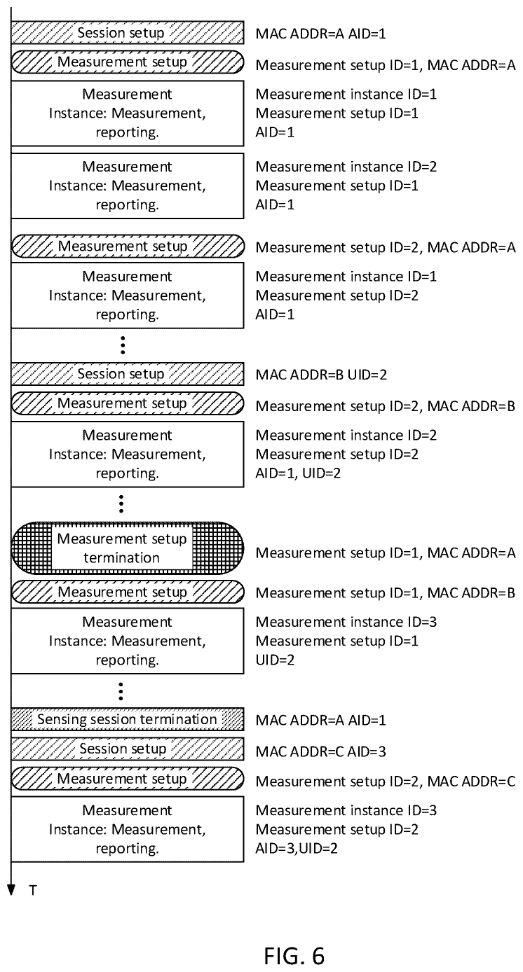

FIG. 6 illustrates an example of a WLAN sensing procedure (also known as a Wi-Fi sensing procedure) according to some embodiments. In examples, a WLAN sensing procedure allows a STA to perform WLAN sensing. In an example, a WLAN sensing procedure enables a STA to obtain one or more sensing measurements of the wireless transmission channel between two or more STAs and or the wireless transmission channel between a receive antenna and a transmit antenna of a STA. In examples, a WLAN sensing procedure is composed of one or more of a sensing session setup, a sensing measurement setup, one or more sensing measurement instances (also referred to as sensing measurement exchanges), sensing measurement setup termination, and sensing session termination.

FIG. 6 illustrates a sensing session setup with a STA with MAC ADDR=A and AID=1, In examples, a sensing session setup establishes a sensing session. In examples, the sensing session may be identified by the AID of the STA involved in the sensing session. FIG. 6 illustrates a sensing measurement setup procedure for the STA with MAC ADDR=A, where the sensing measurement setup ID=1.

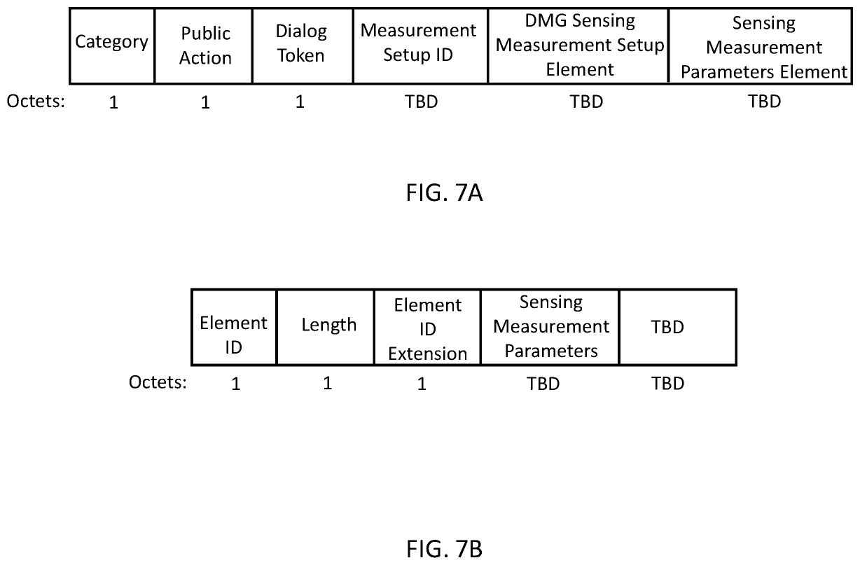

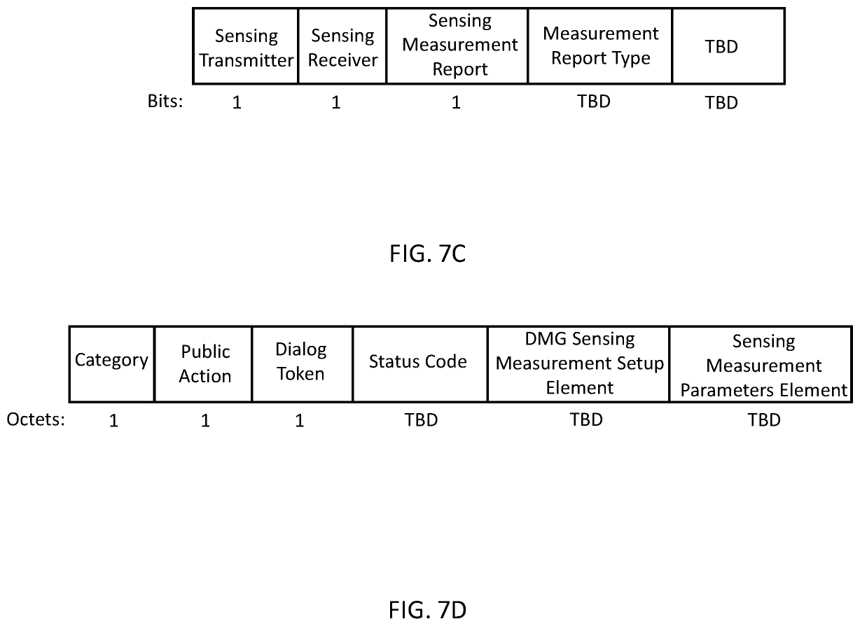

In examples, a sensing measurement setup allows for a sensing initiator and a sensing responder to exchange and agree on operational attributes associated with a sensing measurement instance. A sensing initiator may transmit a Sensing Measurement Setup Request frame to a sensing responder with which it intends to perform a sensing measurement setup. An example of a Sensing Measurement Setup Request frame is provided in FIG. 7A. In examples, the Sensing Measurement Setup Request frame is a Public Action frame, and in examples is identified by a Public Action field value. As shown in the example illustrated in FIG. 7A, in embodiments, a Sensing Measurement Set Request frame format may include one or more of a Category field, a Public Action field, a Dialog Token field, a Measurement Setup ID field, a DMG Sensing Measurement Setup Element field, and a Sensing Measurement Parameters element. In examples, a Category value code is defined for a “Protected Sensing Frame.” In an embodiment, a Protected Sensing Action field is defined in the octet immediately after the Category field in order to differentiate Protected Sensing Frame formats from Public Sensing Frame formats.

FIG. 7B illustrates an example, according to some embodiments, of a Sensing Measurement Parameters element. In examples, a Sensing Measurement Parameters element indicates operational attributes of a corresponding sensing measurement instance. In examples, the Sensing Measurement Parameters element comprises a Sensing Measurement Parameters field. FIG. 7C illustrates an example of a format of a Sensing Measurement Parameters field, according to some embodiments. In an example, a Sensing Measurement Parameters field comprises a Sensing Transmitter subfield. The Sensing Transmitter subfield may be set to 1 to indicate a sensing responder assumes a sensing transmitter role, such as sensing transmitter 504-1. In an example the sensing responder assumes a sensing transmitter role according to the Sensing Transmitter subfield for the Sensing Measurement Setup ID associated with the Sensing Measurement Parameters field. In an example, the Sensing Measurement Parameters field comprises a Sensing Receiver subfield. The Sensing Receiver subfield may be set to 1 to indicate a sensing responder assumes a sensing receiver role, such as sensing receiver 502-1. In an example the sensing responder assumes a sensing receiver role according to the Sensing Receiver subfield for the Sensing Measurement Setup ID associated with the Sensing Measurement Parameters field.

Referring again to FIG. 7C, in examples, a Sensing Measurement Parameters field format includes a Sensing Measurement Report subfield if the Sensing Receiver subfield indicates that the sensing responder should assume a sensing receiver role. In an example, the Sensing Measurement Report subfield may indicate whether or not a sensing responder sends Sensing Measurement Report frames in sensing measurement instances that result from the sensing measurement setup.

Referring again to FIG. 7C, in examples a Sensing Measurement Parameters field format includes a Measurement Report Type subfield. In examples, the Measurement Report Type subfield indicates the type of measurement result reported in sensing measurement instance(s) corresponding to the sensing measurement setup ID, for example when the sensing initiator is a sensing transmitter, such as sensing transmitter 504-1.

In examples, after the sensing responder receives the Sensing Measurement Setup Request frame, the sensing responder may transmit a Sensing Measurement Setup Response frame. An example of a Sensing Measurement Setup Response frame is provided in FIG. 7D. In examples, the sensing responder may use a Status Code field in the Sensing Measurement Setup Response frame to indicate whether the sensing responder accepts the requested sensing measurement setup parameters in the received Sensing Measurement Setup Request frame. In an embodiment, the Status Code field may be set to 0 indicating a successful sensing measurement setup, where the sensing responder accepts the operational attributes included in the Sensing Measurement Setup Request frame. In examples, the sensing responder may indicate in the Sensing Measurement Setup Response frame that the operational attributes included in the Sensing Measurement Setup Request frame sent by the sensing initiator are not accepted, for example by setting a Status Code field to a non-zero value. In examples, the sensing responder may indicate in the Sensing Measurement Setup Response frame preferred sensing measurement parameters, for example to indicate to the sensing initiator one or more operational attributes preferred by the sensing responder. In examples, the sensing responder may indicate to the sensing initiator that preferred sensing measurement parameters are included in the Sensing Measurement Setup Response frame by setting a Status Code field to a non-zero value.

In examples, the sensing initiator may assign a role to the sensing responder as part of the sensing measurement setup sent in the Sensing Measurement Setup Request frame. For example, the sensing initiator may indicate to a sensing responder that the sensing responder is to assume the role of a sensing receiver, such as sensing receiver 502-1, or the role of a sensing transmitter, such as sensing transmitter 504-1, or the role of sensing receiver 502-1 and sensing transmitter 504-1. In examples, sensing initiator may indicate to sensing responder whether the sensing responder sends sensing measurement report frames in sensing measurement instances. In an embodiment, the role assigned to the sensing responder and/or whether the sensing responder sends sensing measurement report frames persists until the sensing measurement setup is terminated.

Referring again to FIG. 6 and the sensing session with the STA with MAC ADDR=A identified by the STA AID, AID=1, the sensing measurement setup is followed by one or more sensing measurement instances and measurement reporting instances which may be performed based on the defined operational attribute set. In the example shown in FIG. 6, the one or more sensing measurement instances for the STA with MAC ADDR=A may be assigned sensing measurement instance IDs, for example, a first sensing measurement instance may be assigned sensing measurement instance ID=1, and a second measurement instance may be assigned sensing measurement instance ID=2. In examples, a sensing measurement instance may be uniquely associated with a sensing measurement setup.

Referring again to FIG. 6, a second sensing measurement setup may be initiated for the STA with MAC ADDR=A, which may be identified as sensing measurement setup ID=2. As with sensing measurement setup ID=1, sensing measurement setup ID-2 may be associated with a second operational attribute set. In examples, after the second sensing measurement setup, any subsequent one or more sensing measurement instances may be performed based on either the first operational attribute set (sensing measurement setup ID=1) or the second operational attribute set (sensing setup measurement ID=2.)

Referring again to FIG. 6, FIG. 6 illustrates a sensing session setup with a STA with MAC ADDR=B and UID=2. In examples, the sensing session may be identified by the UID of the STA with MAC ADDR=B. FIG. 6 further illustrates a sensing measurement setup for the STA with MAC ADDR=B. In the example, the operational attribute set for the sensing measurement setup for the STA with MAC ADDR=B is the same as the second operational attribute set established with the STA with MAC ADDR=A, and the sensing measurement setup ID is used for both the STA with MAC ADDR-A and the STA with MAC ADDR=B. That is, a sensing measurement setup ID (which may also be referred to as a sensing measurement setup label) may apply to one or more STA. In examples according to FIG. 6, subsequent sensing measurement instances associated with sensing measurement setup ID-2 may be associated with the STA with MAC ADDR=A, the STA with MAC ADDR=B, or with both the STA with MAC ADDR=A and the STA with MAC ADDR=B. An example of one-to-many triggering is shown in FIG. 6 where AID=1 and UID-2 are both associated with a single measurement instance and measurement reporting (measurement instance ID=2 and measurement setup ID=2.)

In examples, an operational attribute set of a sensing session may be terminated by performing a sensing measurement setup termination procedure, for example as is shown in FIG. 6 for sensing measurement setup ID=1 and the STA with MAC ADDR=A. In examples, the sensing measurement setup ID of a terminated sensing measurement setup may be used for a subsequent sensing measurement setup. This is shown in FIG. 6 where a sensing measurement setup with ID=1 is established for the STA with MAC ADDR=B, after the termination of the sensing measurement setup ID=1 with the STA with MAC ADDR=A. In some embodiments, a sensing session may be terminated using a sensing session termination procedure, as shown in FIG. 6.

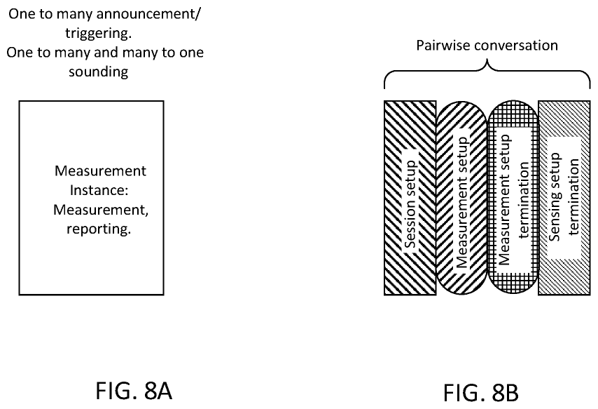

FIG. 8A illustrates exchanges between a sensing initiator and a sensing responder that may be one-to-many or many-to-one. In examples, a sensing measurement instance (sensing measurement exchange) and/or measurement reporting may have a one-to-one (single device to single device) announcement or triggering or may have a one-to-many (single device to multiple device) announcement or triggering. In examples, a sensing measurement instance may have a one-to-one, one-to-many, or many-to-one (many devices to a single device) sounding.

As previously described, a sensing session is an agreement between a sensing initiator and a sensing responder to participate in a WLAN sensing procedure, that is a sensing session is pairwise and in examples, may be identified by MAC addresses of the sensing initiator and the sensing responder or by the associated AID/UID. FIG. 8B shows an example of pairwise exchanges or procedures that may take place between a sensing initiator and a sensing responder related to a sensing session, which include a sensing session setup, a sensing measurement setup, a sensing measurement setup termination, and a sensing session termination.

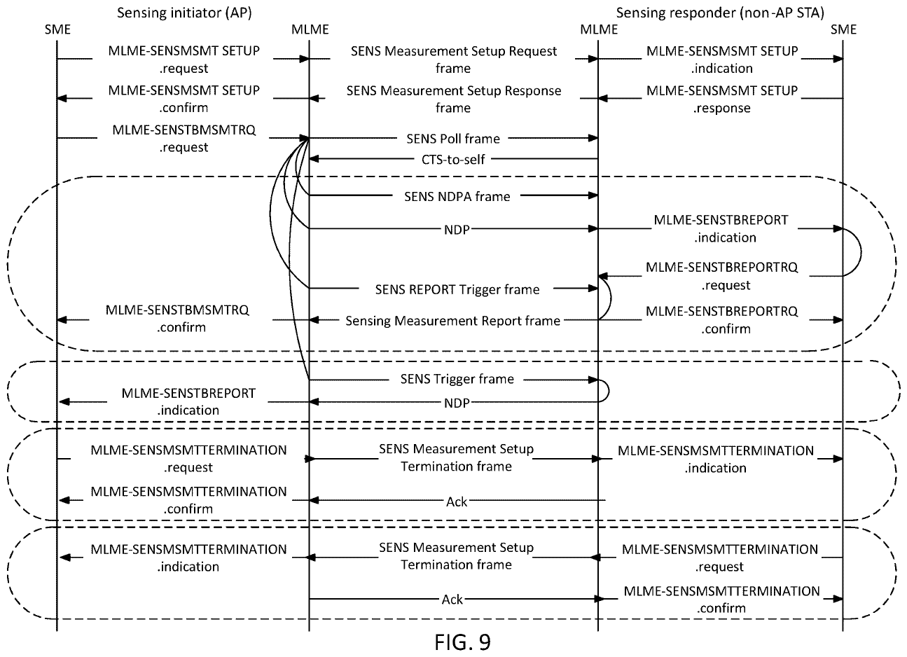

In examples, a sensing measurement instance of a WLAN sensing procedure may be a trigger-based (TB) sensing measurement instance. FIG. 9 depicts a message flow of a sensing session of a WLAN sensing procedure comprising a sensing measurement setup procedure followed by one or more trigger-based (TB) sensing measurement instances that consists of either NDPA sounding or trigger frame (TF) sounding, following by a sensing measurement setup termination procedure, according to some examples. In examples, a TB sensing measurement instance may be used where the sensing initiator is an AP, and one or more non-AP STAs are sensing responders. In examples, a TB sensing measurement instance may include a polling phase, an NDPA sounding phase, a trigger frame (TF) sounding phase, and a reporting phase.

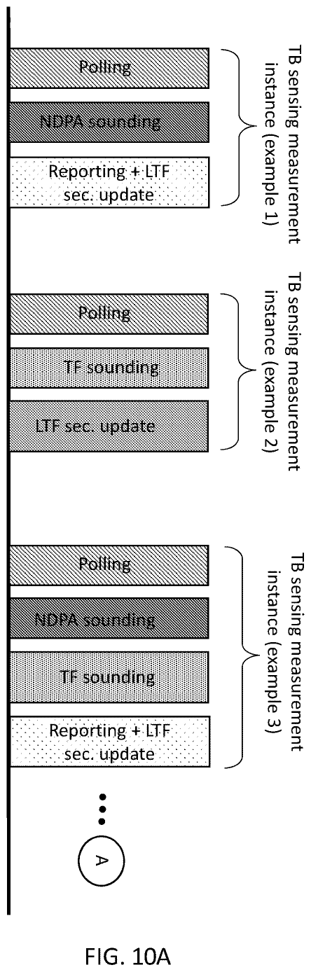

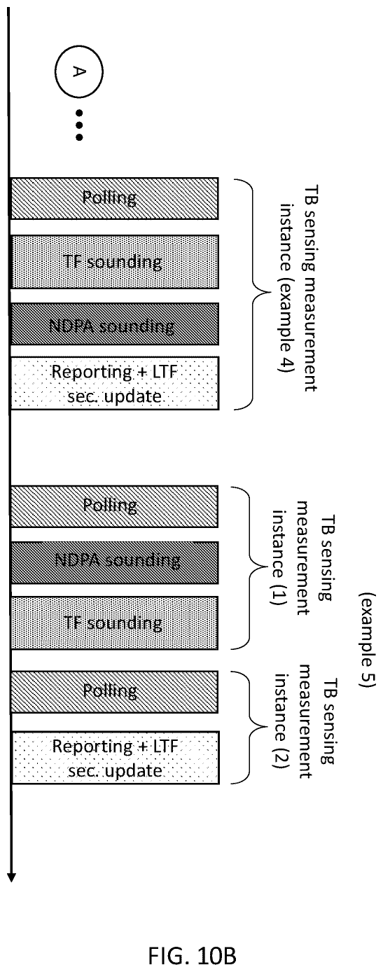

FIG. 10A and FIG. 10B illustrate five examples of TB sensing measurement instances. Example 1 of FIG. 10A illustrates an example of a TB sensing measurement instance comprising a polling phase, an NDPA sounding phase, and a reporting phase. Example 2 of FIG. 10A illustrates an example of a TB sensing measurement instance comprising a polling phase and a TF sounding phase. Example 3 of FIG. 10A and Example 4 of FIG. 10B illustrate two examples of a TB sensing measurement instance comprising a polling phase, an NDPA sounding phase, a TF sounding phase, and a reporting phase. Example 5 of FIG. 10B shows two TB sensing measurement instances, where the first TB sensing measurement instance comprises a polling phase, an NDPA sounding phase, and a TF sounding phase, and the second TB sensing measurement instance comprises a polling phase and a reporting phase. In examples, the TF sounding phase of the TB sensing measurement instance may precede the NDPA sounding phase of the TB sensing measurement instance, for example as in Example 4. In examples, the NDPA sounding phase of the TB sensing measurement instance may precede the NDPA sounding phase of the TB sensing measurement instance, for example as in Example 3. In some embodiments, the reporting phase of the second TB sensing measurement instance in Example 5 may be addressed to sensing responders other than the sensing responders involved in the TF sounding phase or the NDPA sounding phase of the first TB measurement instance.

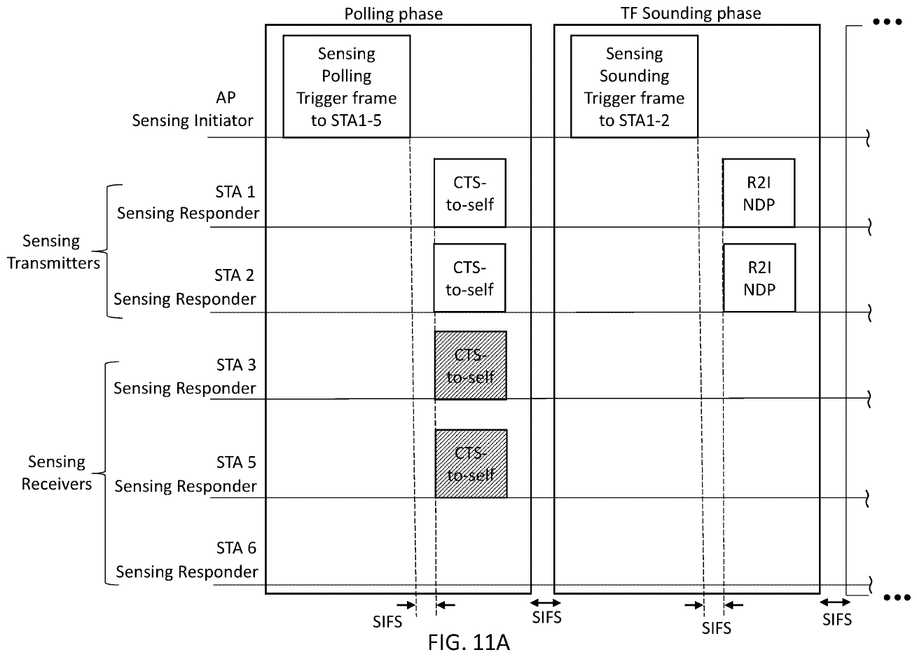

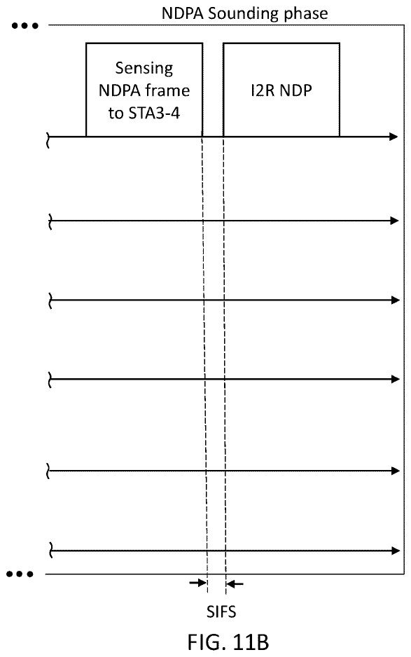

FIG. 11A and FIG. 11B are one example of a TB sensing measurement instance with a single AP in the role of a sensing initiator and five STAs, referred to as STA 1, STA 2, STA 3, STA 4, and STA 5, all of which in the example are sensing responders. In the example, the TB sensing measurement instance comprises a polling phase, a TF sounding phase, and an NDPA sounding phase. In the example, STA 1 and STA 2 are sensing transmitters, such as sensing transmitter 504-1 and sensing transmitter 504-2. In the example of FIG. 11A and FIG. 11B, STA 3, STA 4, and STA 5 are sensing receivers, such as sensing receiver 502-1, sensing receiver 502-2, and sensing receiver 502-3. In examples, in the polling phase, the AP as the sensing initiator transmits a Sensing Polling Trigger frame to STA 1, STA 2, STA 3, STA 4, and STA 5. In an embodiment, sensing transmitter STA 1 (504-1) and sensing transmitter STA 2 (504-2) respond to the Sensing Polling Trigger frame with an indication that the STA is available to participate in a sensing measurement instance. In examples, the indication is a CTS-to-self frame. In an embodiment, sensing receiver STA 3 (502-1) and sensing receiver STA 4 (502-2) respond to the Sensing Polling Trigger frame with an indication that the STA is available to participate in a sensing measurement instance. In examples, the indication is a CTS-to-self frame. In the example, sensing receiver STA 5 (502-3) does not respond to the Sensing Polling Trigger frame sent by the AP as the sensing initiator, indicating that STA 5 (502-3) will not participate in the sensing measurement instance.

The sensing measurement instance of FIG. 11A and FIG. 11B includes a TF Sounding phase. In examples, in the TF Sounding phase, the AP as the sensing initiator sends a Sensing Sounding Trigger frame to sensing transmitter STA 1 (504-1) and to sensing transmitter STA 2 (504-2). In examples, a period of one or more SIFS elapses between the AP receiving the CTS-to-self frames from STA 1, STA 2, STA 3, and STA 4 before sending the Sensing Sounding Trigger frame. In examples, responsive to receiving the Sensing Sounding Trigger frame, sensing transmitter STA 1 (504-1) and sensing transmitter STA 2 (504-2) send sensing transmissions to the AP. In examples, the sensing transmissions may comprise NDP transmissions. In an example, one or more of the NDP transmissions to the AP may be “Responder to Initiator” (R2I) NDP transmissions (as shown in the example of FIG. 11A and FIG. 11B). Responder to Initiator transmissions may also be referred to as Sensing Responder to Sensing Initiator (SR2SI) transmissions or SR2SI NDPs. In examples, a period of one or more SIFS elapses between sensing transmitter STA 1 (504-1) receiving the Sensing Sounding Trigger frame and transmitting a sensing transmission, and in examples a period of one or more SIFS elapses between sensing transmitter STA 2 (504-2) receiving the Sensing Sounding Trigger frame and transmitting a sensing transmission. In examples, the AP may assume the role of sensing receiver 502-4, and the AP may make sensing measurements on the sensing transmissions from sensing transmitter STA 1 (504-1) and sensing transmitter STA 2 (504-2).

Referring again to FIG. 11A and FIG. 11B, in a NDPA sounding phase, the AP acting as sensing initiator assumes the role of sensing transmitter (504-3). In examples, the AP as sensing transmitter 504-3 transmits a sensing transmission. In examples, the sensing transmission may be a broadcast transmission. In examples, the sensing transmission may be a unicast transmission to one or more STAs, for example to sensing receiver STA 3 (502-1) and/or to sensing receiver STA 4 (502-2). In examples, a period of one or more SIFS elapses between the AP as sensing transmitter 504-3 sending the sensing NDPA frame and when the AP as sensing transmitter 504-3 sends the one or more sensing transmissions. In examples, one or more of the sensing transmissions may be a full bandwidth NDP frame. In examples, one or more of the sensing transmissions may be a partial bandwidth NDP frame. In examples, one or more of the NDP frames may be an “Initiator to Responder” (I2R) NDP frame. Initiator to Responder transmissions may also be referred to as Sensing Initiator to Sensing Responder (SI2SR) transmissions or SI2SR NDPs.

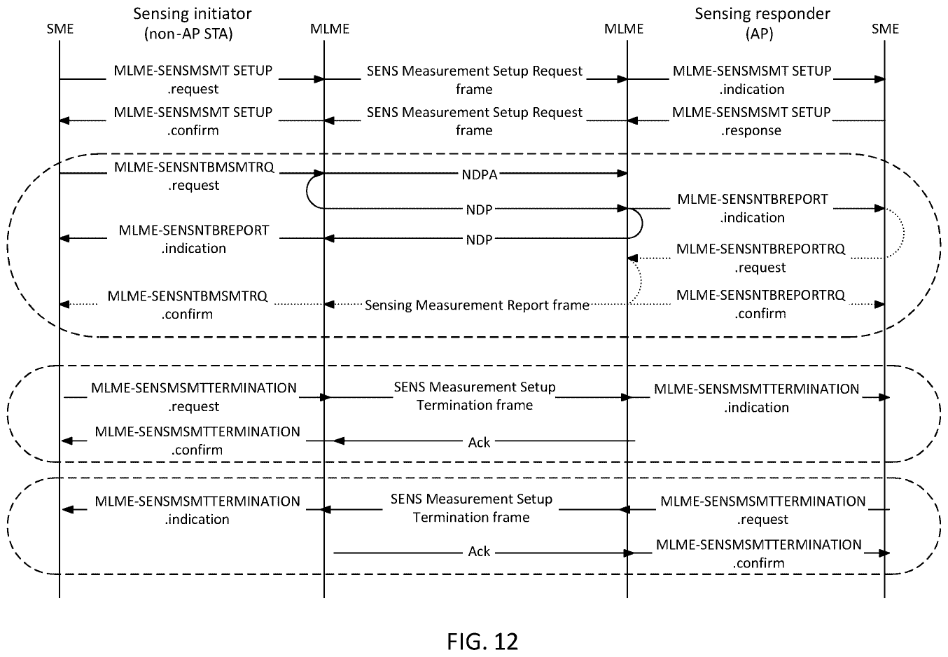

In examples, a sensing measurement instance of a WLAN sensing procedure may be a non-trigger-based (non-TB) sensing measurement instance. FIG. 12 depicts a message flow of a sensing measurement setup procedure followed by one or more non-TB sensing measurement instances of a WLAN sensing procedure that consist of one or more of downlink sounding or uplink sounding, according to some embodiments, followed by a sensing measurement setup termination procedure, according to some examples. In examples, a non-TB sensing measurement instance may be used where the sensing initiator is a non-AP STA, and an AP is the sensing responder. In examples of uplink sounding as shown in FIG. 12, the sensing initiator (non-AP STA) acting as a sensing transmitter (for example, sensing transmitter 504-1) transmits a sensing announcement frame followed by a sensing transmission. In examples, the sensing announcement frame may be an NDPA frame. In examples, the sensing transmission may be an NDP frame. In examples, responsive to receiving the sensing transmission, the AP acting as a sensing receiver (for example, sensing receiver 502-1), may transmit to the sensing initiator (non-AP STA in the role of sensing transmitter 504-1) a sensing measurement report, for example, one or more Sensing Measurement Report frames. In examples of downlink sounding as shown in FIG. 12, the sensing initiator (non-AP STA) acting as a sensing receiver (for example, sensing receiver 502-1) transmits a sensing announcement frame. In examples, the sensing announcement frame may be an NDPA frame. In examples, responsive to receiving the sensing announcement frame, the AP acting as sensing transmitter (for example, sensing transmitter 504-1) may transmit one or more sensing transmissions. In examples, one or more of the sensing transmissions may be an NDP frame, for example, an SR2SI NDP frame or an SI2SR NDP frame. In examples, the non-AP STA acting as a sensing receiver (502-1), responsive to receiving a sensing transmission, may make a sensing measurement on the sensing transmission. In examples, the sensing measurement setup may be terminated by the sensing initiator or the sensing responder transmitting a SENS Measurement Setup Termination frame. In examples, the sensing responder or sensing initiator (respectively) may respond with an acknowledgment.

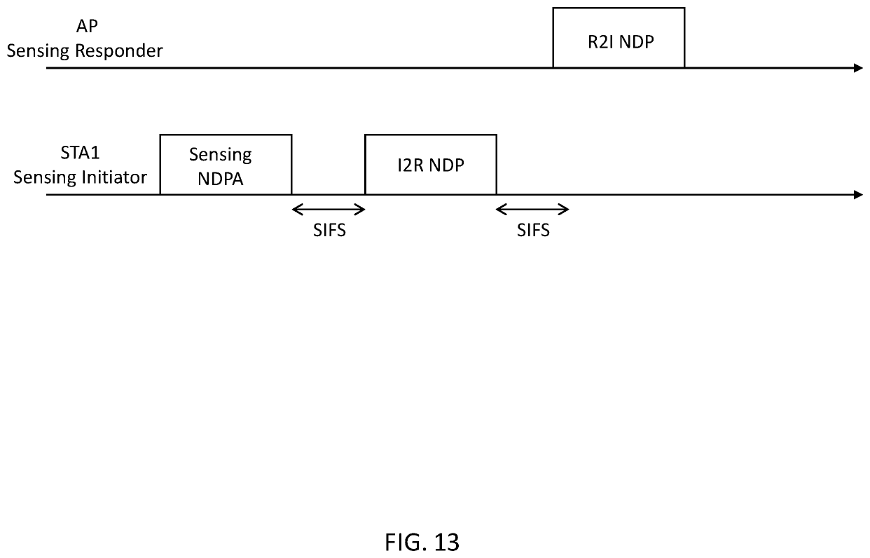

FIG. 13 illustrates a detailed example of a non-TB sensing measurement instance, according to some embodiments. In examples, STA 1 acting as sensing initiator and sensing transmitter, such as sensing transmitter 504-1, transmits a sensing announcement frame. In examples, the sensing announcement frame may be a sensing NDPA frame. In examples, one or more SIFS may elapse followed by STA 1 acting as sensing initiator and sensing transmitter (such as sensing transmitter 504-1) transmitting one or more sensing transmissions. In examples, one or more of the sensing transmissions may be an NDP frame, for example, an SR2SI NDP frame or an SI2SR NDP frame′. In an example, STA 1 acting as sensing initiator and sensing receiver, such as sensing receiver 502-1, transmits a sensing announcement frame. In examples, the sensing announcement frame may be a sensing NDPA frame. In examples, one or more SIFS may elapse, followed by AP 1 acting as sensing responder and sensing transmitter (such as sensing transmitter 504-1) transmitting one or more sensing transmissions. In examples, one or more of the sensing transmissions may be an NDP frame.

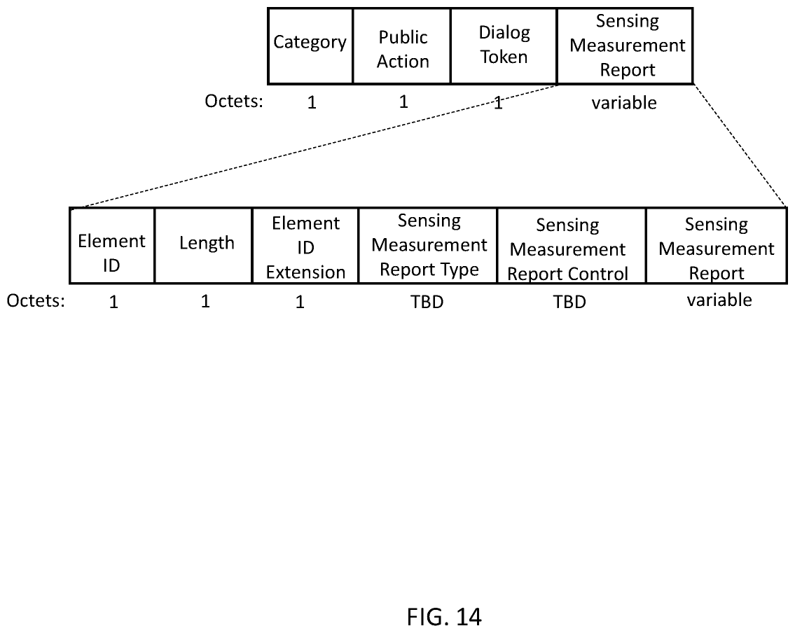

FIG. 14 illustrates an example of a Sensing Measurement Report frame. In some embodiments, a Sensing Measurement Report frame is a Public Action category or a Public Action No Ack category. In some examples, a Sensing Measurement Report frame may be transmitted to provide WLAN sensing measurements, for example to a sensing agent or a sensing algorithm of a sensing initiator. In examples, a Sensing Measurement Report frame may comprise one or more Sensing Measurement Report elements. A Sensing Measurement Report element may comprise a single sensing measurement report, in some embodiments. In examples, a Sensing Measurement Report element may include a Sensing Measurement Report type field, which may contain a number that identifies the type of sensing measurement report. For example, a value of 0 may indicate that the sensing measurement type is a CSI measurement, whereas a non-zero value may indicate that the sensing measurement type is a TD-CRI measurement.

Referring again to FIG. 14, in embodiments, a Sensing Measurement Report element may include a Sensing Measurement Report Control field. In examples, the Sensing Measurement Report Control field may contain information necessary to interpret the Sensing Measurement Report field. For example, the Sensing Measurement Report Control field format may comprise one or more subfields. In an embodiment, one or more subfields of the Sensing Measurement Report Control field may include PHY layer parameters used by the sensing receiver when performing the sensing measurement, for example receiver antenna beamforming or spatial layer information.

In a sensing session, exchanges of transmissions between one or more of plurality of sensing receivers 502-(1-M) and one or more of plurality of sensing transmitters 504-(1-N) may occur. In an example, control of these transmissions may be with the MAC layer of the IEEE 802.11 stack. According to an implementation, one or more of plurality of sensing receivers 502-(1-M) may secure a TXOP which may be allocated to one or more sensing transmissions by one or more of plurality of sensing transmitters 504-(1-N). According to an implementation, one or more of plurality of sensing receivers 502-(1-M) may allocate channel resources (or RUs) within a TXOP to the one or more of plurality of sensing transmitters 504-(1-N). In an example, one or more of plurality of sensing receivers 502-(1-M) may allocate the channel resources to the one or more of plurality of sensing transmitters 504-(1-N) by allocating time and bandwidth within the TXOP to the one or more of plurality of sensing transmitters 504-(1-N).

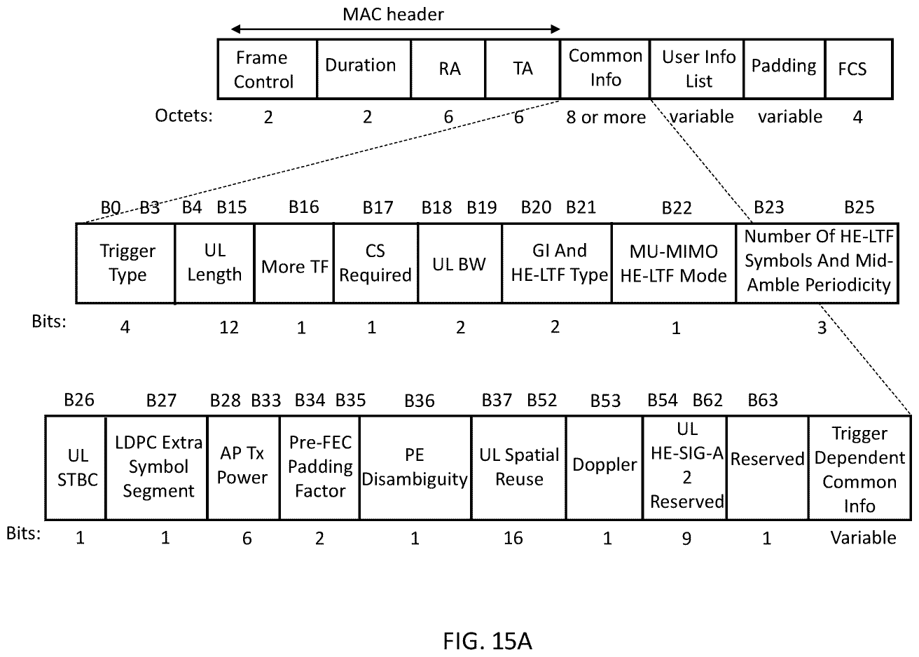

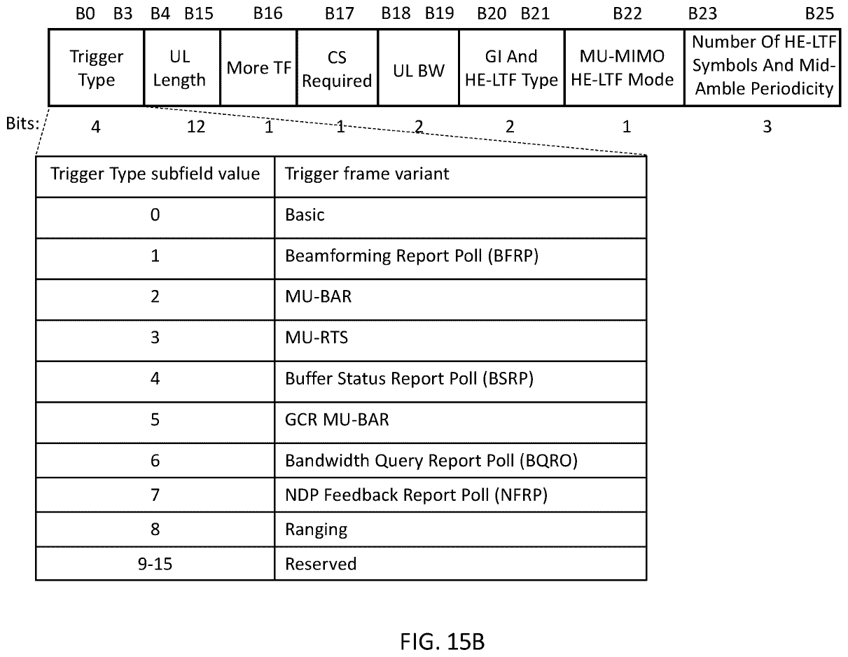

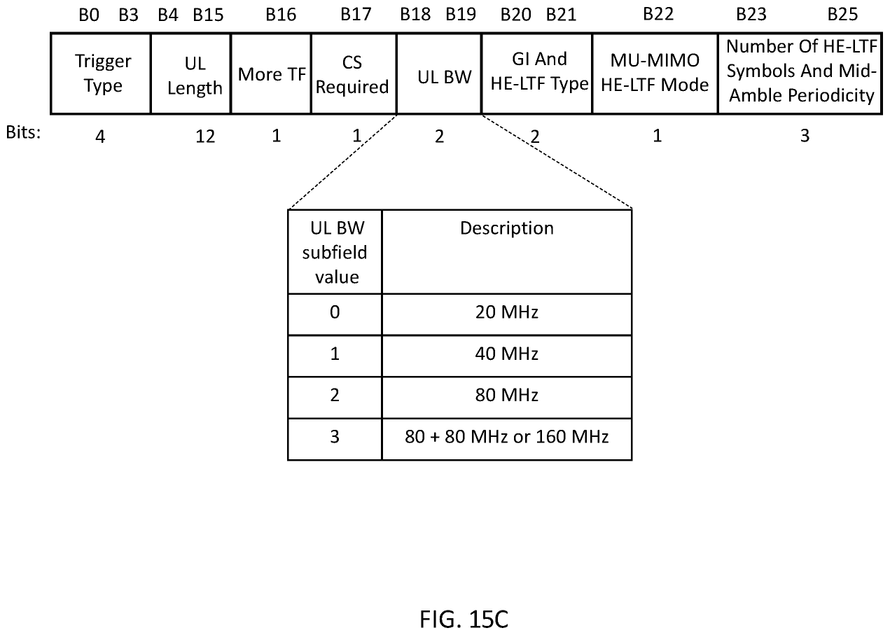

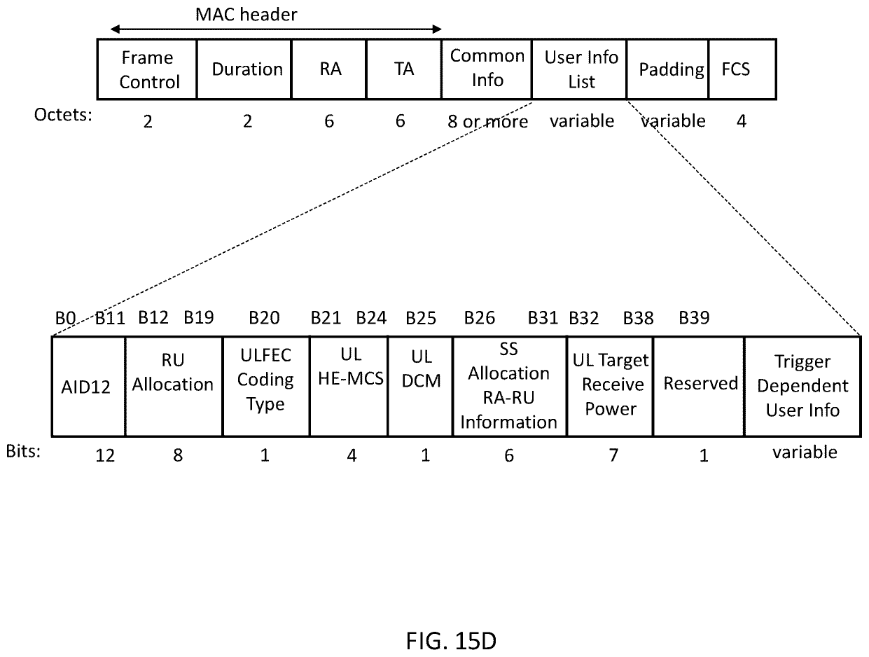

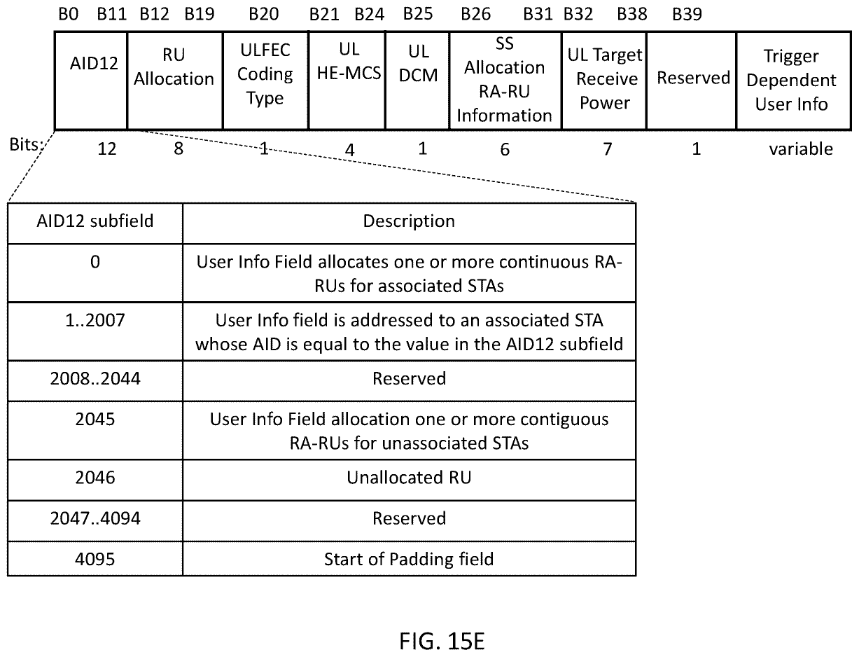

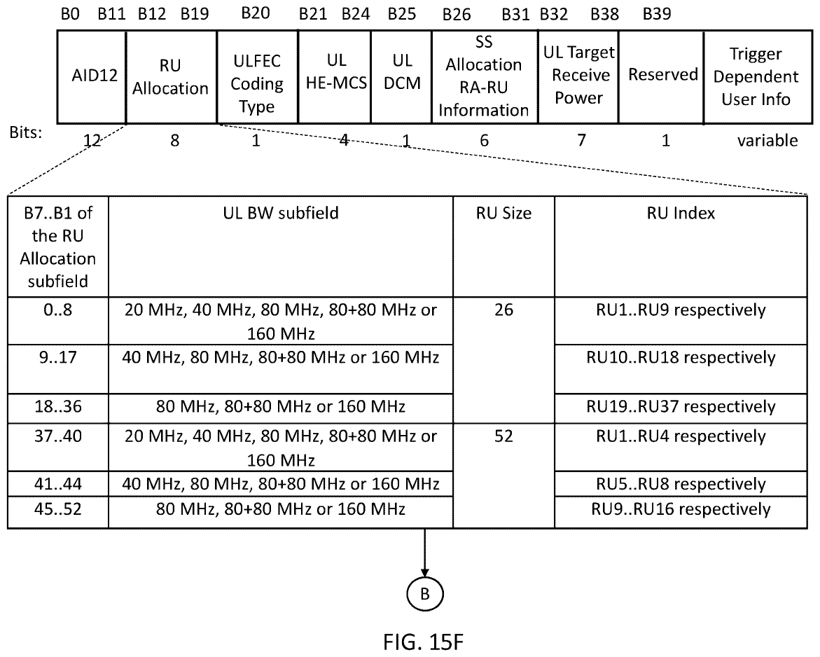

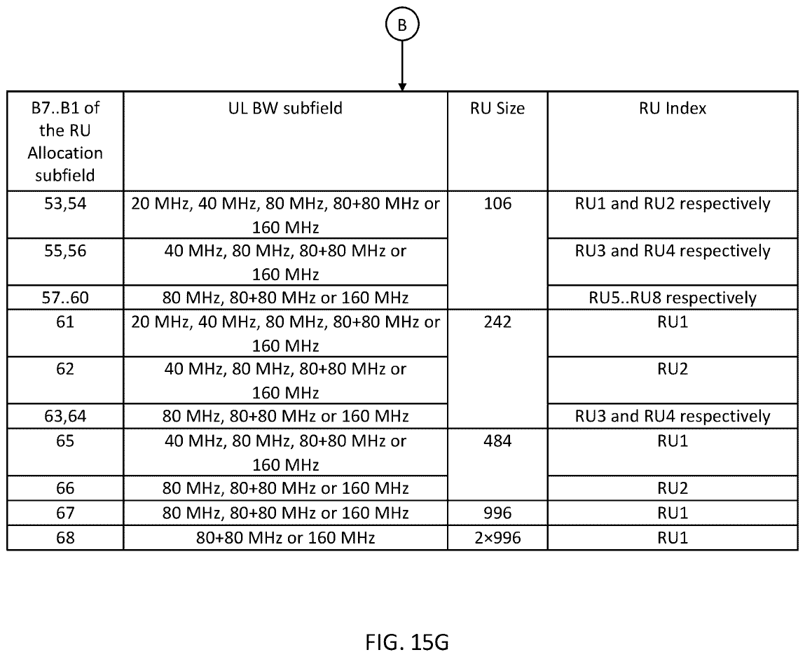

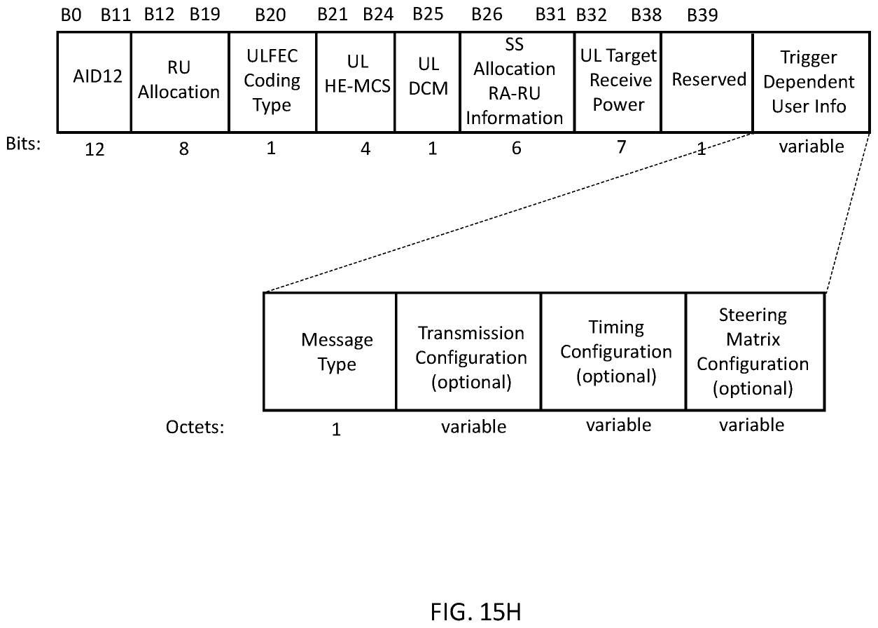

According to an implementation, an example of a hierarchy of fields within sensing trigger message is shown in FIG. 15A to FIG. 15H.

As described in FIG. 15A, the Common Info field may contain information which is common to one or more of plurality of sensing transmitters 504-(1-N). According to some implementations, the requirement of an NDPA preceding an NDP may be optional. This may be indicated to one or more of plurality of sensing transmitters 504-(1-N) and may for example be encoded into a “Trigger Dependent Common Info” field if the requirement is common to plurality of sensing transmitters 504-(1-N), or into a “Trigger Dependent User Info” field if the requirement is specific to one or more of plurality sensing transmitters sensing transmitters 504-(1-N). According to an example, the requirement for a sensing announcement (for example, and NDPA) preceding a sensing response NDP may be encoded by a single bit where 0 (bit clear) indicates that a sensing announcement is optional and 1 (bit set) indicates that a sensing announcement is required.

As described in FIG. 15B, a Trigger Type (within B0 . . . 3 of “Common Info” field) may be defined which represents a sensing trigger message. In examples, a sensing Trigger message may have a Trigger Type subfield value of any Reserved value from 9-15, for example a Sensing Trigger message may have a Trigger Type subfield value of 9. In an example of triggering a sensing transmission from a sensing transmitter 504-1, a Trigger Dependent User Info field may include sensing trigger message data. In an implementation, a time-synchronized sensing transmission may be required from plurality of sensing transmitters 504-(1-N) responding to a sensing trigger message. In an example, the requirement for one or more time-synchronized sensing transmissions may be encoded into a Trigger Dependent Common Info field. According to an example, the requirement for one or more time-synchronized sensing transmissions may be encoded by a single bit where 0 (bit clear) represents a request for a normal or non-time-synchronized response and 1 (bit set) represents a request for a time-synchronized response. In some examples, a method of time-synchronization may be requested in the sensing trigger. In examples, the method of time-synchronization to be requested may be encoded into a Trigger Dependent Common Info field. In examples the encoding may use two bits as shown in the following table.

| Encoding | Method | Description |
|---|---|---|
| 00 | A | Sensing announcement followed by sensing NDP. |
| 01 | B | Padding followed by a sensing response message. |
| 10 | C | Sensing NDP without an initial sensing |
| | | announcement. |
| 11 | N/A | For future use or extensions. |

As described in FIG. 15C the sensing trigger message may have an uplink bandwidth (UL BW) subfield value of 0, 1, 2 or 3 corresponding to bandwidths of 20 MHz, 40 MHz, 80 MHz, or 80+80 MHz (160 MHz).

As described in FIG. 15D, the User Info List contains information which is specific to each of the plurality of sensing transmitters 504-(1-N). In examples, the User Info List may include the AID of a sensing transmitter, an RU allocation for a sensing transmitter, and other Trigger Dependent User Info.

As described in FIG. 15E, the AID12 subfield of the User Info List illustrated in FIG. 15D may be used to address a specific sensing transmitter of the plurality of sensing transmitters 504-(1-N).

As described in FIG. 15F and FIG. 15G, the RU Allocation subfield is used to allocate resource units (RU) to each of the plurality of sensing transmitters 504-(1-N).

As described in FIG. 15H, the Trigger Dependent User Info subfield may be used to request the transmission configuration and/or steering matrix configuration for one or more of the plurality of sensing transmitters 504-(1-N) that the sensing trigger message is triggering.

### C. Systems and Methods for Wi-Fi Network Evaluation

The present disclosure generally relates to systems and methods for Wi-Fi sensing. In particular, the present disclosure relates to systems and methods for Wi-Fi network evaluation.

In a Wi-Fi sensing system, there may be multiple sensing capable devices or stations (STAs) communicating with an access point (AP), and there may be multiple access points. In examples, access points that are physically located close to each other may have overlapping coverage areas. Further, interference may occur in the overlapping coverage areas.

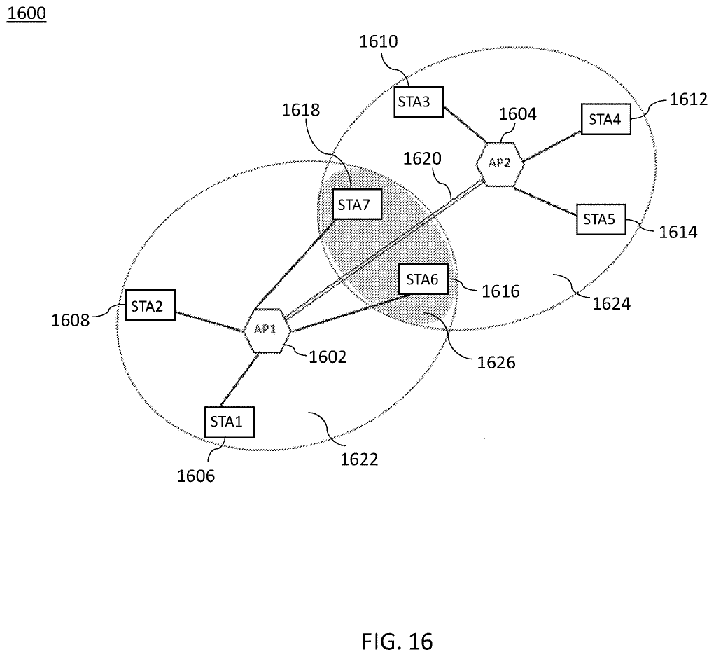

FIG. 16 depicts example 1600 of a Wi-Fi sensing system including two access points connected via a backhaul link, according to some embodiments.

In the example of FIG. 16, the Wi-Fi sensing system includes two access points including AP1 1602 and AP2 1604, and seven stations (non-AP STAs) including STA1 1606, STA2 1608, STA3 1610, STA4 1612, STA5 1614, STA6 1616, and STA7 1618. In examples, STA1 1606, STA2 1608, STA3 1610, STA4 1612, STA5 1614, STA6 1616, and STA7 1618 may be connected wirelessly to AP1 1602 or AP2 1604. Further, AP1 1602 and AP2 1604 may be connected with each other via backhaul link 1620. In an example, backhaul link 1620 may be a wired link (for example, CAT6 Ethernet). In some examples, backhaul link 1620 may be a wireless link in a separate frequency band to the links to the seven stations including STA1 1606, STA2 1608, STA3 1610, STA4 1612, STA5 1614, STA6 1616, and STA7 1618. In some examples, backhaul link 1620 may be a wireless link in the same frequency band as the links to the seven stations including STA1 1606, STA2 1608, STA3 1610, STA4 1612, STA5 1614, STA6 1616, and STA7 1618. FIG. 16 further shows a coverage area of AP1 1602 (represented by reference number “1622”) and a coverage area of AP2 1604 (represented by reference number “1624”). As illustrated in FIG. 16, there is an overlapping coverage area of AP1 1602 and coverage area of AP2 1604 (represented by reference number “1626”). In examples, if AP1 1602 and AP2 1604 are using the same frequency channels for data transmissions or sensing transmissions with STA1 1606, STA2 1608, STA3 1610, STA4 1612, STA5 1614, STA6 1616, and STA7 1618, then transmissions between AP1 1602 and STA1 1606, STA2 1608, STA3 1610, STA4 1612, STA5 1614, STA6 1616, or STA7 1618 in the overlapping coverage area may interfere with transmissions between AP 2 1604 and STA1 1606, STA2 1608, STA3 1610, STA4 1612, STA5 1614, STA6 1616, or STA7 1618 in the overlapping coverage area. Each coverage area shows the approximate limit to the region where a station can connect reliably to each access point and provide an acceptable level of service. Further, in the overlapping coverage area, a station may be connected to either of the access points. In the example of FIG. 16, STA6 1616 and STA7 1618 are shown to be in the overlapping coverage area, and each has a communication link to AP1 1602, even though they may have instead had a communication link to AP2 1604.

In certain scenarios, coverage areas of access points in a Wi-Fi network may overlap significantly, and interference may occur in the overlapping coverage areas. Further, stations in the Wi-Fi network may be connected to access points that are physically distant when an equally suitable, physically closer access point is available. The interference may result in packet collision or packet loss during data transmissions or sensing transmissions. The interference may also limit the maximum channel bandwidth resource that each access point can use. It may not be known in the Wi-Fi network where overlapping coverage areas exist, or how significant they are. To minimize packet collision or packet loss due to interference in overlapping coverage areas between access points, and to maximize the channel bandwidth resource that each access point can use, it is necessary to detect the overlapping coverage areas of multiple access points.

The present disclosure describes a method to detect overlapping coverage areas of multiple access points in a Wi-Fi network using a Wi-Fi sensing system in the Wi-Fi network. In examples, the information of the detected overlapping coverage areas may be used for Wi-Fi network adjustments to decrease packet collision or packet loss due to interference in overlapping coverage areas between access points, and/or to increase the channel bandwidth resource that each access point can use. In examples, information about the overlapping coverage areas of the Wi-Fi network provided through methods performed by the Wi-Fi system may be used to optimize the communication performance or throughput of the Wi-Fi network. The Wi-Fi network may be referred to throughout the detailed description as a Wi-Fi sensing system, as the Wi-Fi sensing system uses some or all of the devices and components of the Wi-Fi network.

In a Wi-Fi sensing system, each station may have a communication link with an access point, and a proximity link with an access point. The sensing measurements may be made using the communication link. If a station has a communication link with an access point, however, it has a proximity link with a different access point, then the station may be determined to be in an overlapping coverage area. Further, the existence of the overlapping coverage area may be determined or identified, for example using the system and methods described herein. In examples, interference may occur in the overlapping coverage area. In order to mitigate or reduce the interference, the information related to one or more overlapping coverage areas may be provided from the Wi-Fi sensing system to a Wi-Fi network coordination agent 564.

In some examples, actions of Wi-Fi network adjustments may be taken by the Wi-Fi network coordination agent 564 automatically on behalf of the Wi-Fi system. For example, Wi-Fi network coordination agent 564 may adjust the output transmission power of one or more access points or may adjust the frequency channels or frequency bands used by one or more access points or may adjust the beamforming or beamsteering applied by one or more access points. In some examples, Wi-Fi network coordination agent 564 may output Wi-Fi network adjustment recommendations to a system administrator of the Wi-Fi network. In examples, Wi-Fi network coordination agent 564 may display one or more Wi-Fi network adjustment recommendations on a device display, for example a display of remote processing device 506. In examples, one or more overlapping coverage areas or one or more Wi-Fi network adjustment recommendations may be displayed to a system administrator by using a dashboard or other diagrammatic representation. In examples, Wi-Fi network coordination agent 564 may provide Wi-Fi network adjustment recommendations to a system administrator of the Wi-Fi network by sending messages to a device of the system administrator, for example a device connected to the Wi-Fi network. The system administrator may be an individual or team responsible for managing the Wi-Fi network or system. For example, the system administrator may choose to relocate one or more access points to make the Wi-Fi network more efficient for data transmissions.

An example of the Wi-Fi sensing system is illustrated in FIG. 16 as described previously. FIG. 16 shows communication links between each station and an access point. In an implementation, a proximity link between a station and the access point that is physically closest to the station may be defined. In examples, each station may have a communication link with an access point, and a proximity link with an access point. Each station may only have one communication link and one proximity link. The communication link and the proximity link of a station may or may not be the same. In examples, the communication link and the proximity link of a station may be the same (for example, where the station sits in a single coverage area, that is a coverage area of a single access point). In some examples, the communication link and the proximity link of a station may be different (for example, where the station sits in an overlapping coverage area). In scenarios where there are a number of stations that each have a different communication link and proximity link, then there may be significant overlapping coverage areas. Based on sensing measurements made using a communication link topology, a proximity link topology may be determined. Examples by which the proximity link topology may be determined are described in detail below.

Referring to FIG. 5, according to an implementation, a networking device (for example, remote processing device 506) operates within a Wi-Fi network (for example, network 580) including a plurality of network devices which may be configured to perform a method for Wi-Fi network evaluation. In examples, the plurality of network devices may include a plurality of access points which may be sensing receivers 502-(1-M) or sensing transmitters 504-(1-N) and a plurality of stations which may be sensing transmitters 504-(1-N) or sensing receivers 502-(1-M). In an example, if an access point is the sensing initiator and sensing receiver in a trigger-based (TB) sensing session, sensing measurement reports may be transferred from the access point to other network elements (such as remote processing device 506, sensing agent 556, localizer 560, physical network determination agent 562, or Wi-Fi network coordination agent 564) for further processing or usage. In another example, if an access point is the sensing initiator and sensing transmitter while a station is the sensing responder and sensing receiver in a non-trigger-based (non-TB) sensing session, sensing measurement reports may be transferred from the station to the access point over the air and then to other network elements (such as remote processing device 506, sensing agent 556, localizer 560, physical network determination agent 562, or Wi-Fi network coordination agent 564) for further processing or usage.

According to an implementation, sensing agent 556 of remote processing device 506 may be configured to identify a communication link topology of the Wi-Fi network, the communication link topology being defined by a plurality of communication links, each communication link being between an associated pair from the plurality of stations and the plurality of access points. In an example, a first communication link may be between a station and an access point (for example station 1608 and access point 1602, as illustrated in FIG. 16), and a second communication link may be between a different station and the same access point (for example, station 1606 and access point 1602, as illustrated in FIG. 16). In the example, the communication link topology may include one or more communication links in the Wi-Fi network. In examples, the communication link topology may include the first communication link and the second communication link.

In an implementation, sensing agent 556 may receive a plurality of sensing measurements measured according to the communication link topology. The plurality of sensing measurements measured according to the communication link topology are a plurality of sensing measurements made on communication links. In examples, sensing agent 556 may receive the plurality of sensing measurements from one or more of plurality of sensing receivers 502-(1-M), for example if the one more sensing receivers of the plurality of sensing receivers 502-(1-M) are access points in a trigger-based (TB) sensing session. In examples, sensing agent 556 may receive the plurality of sensing measurements from one or more of plurality of sensing transmitters 504-(1-N), for examples if the one or more sensing transmitters are access points in a non-trigger-based (non-TB) sensing session.

According to an implementation, physical network determination agent 562 may determine a proximity link topology of the Wi-Fi network based on the plurality of sensing measurements. In an example, the proximity link topology may be defined by a plurality of proximity links, each proximity link being between a proximal network pair from a plurality of network pairs from the plurality of stations and the plurality of access points. In an implementation, physical network determination agent 562 may determine the proximity link topology based on identifying proximal network pairs. Each proximal network pair may be between one of the plurality of stations and a corresponding one of the plurality of access points that is a closest access point to the one of the plurality of stations based on at least one of the plurality of sensing measurements. In an example, the at least one of the plurality of sensing measurements may be indicative of a motion in a sensing space associated with the Wi-Fi network. In examples, the motion may be selected from a plurality of detected motions as the motion closest to one of the plurality of network devices.

According to an implementation, localizer 560 may detect or determine a motion in the Wi-Fi network. Further, localizer 560 may determine to which network device in the Wi-Fi network the motion is closest. In examples, localizer 560 may determine the closest network device using Wi-Fi sensing carried out by network devices in the Wi-Fi network over communication links. In an implementation, localizer 560 may make repeated measurements, each at one or more locating sampling instances “s”, over a period of time (analysis period) which may be used to detect changes in motion and changes in the location of motion (related to network devices in the Wi-Fi network). In examples, a number of consecutive locating sampling instances may be referred to as a motion detection window “w_{md}”.

An example of the closest network devices to a detected motion over a number of locating sampling instances is described in Table 1 provided below.

TABLE 1
An example of the closest network devices of a single motion

| | | | |
|---|---|---|---|
| Locating | Closest | Motion | Analysis |
| Sampling Instance | Network Device | Detection Window | Period |

| | | |
|---|---|---|
| s₁ | STA1 | w_{md}(1) |
| s₂ | STA1 | |
| s₃ | STA2 | |
| s₄ | AP1 | |
| s₅ | STA2 | |
| s₆ | STA1 | w_{md}(2) |
| s₇ | AP1 | |
| s₈ | STA1 | |
| s₉ | AP1 | |
| s₁₀ | AP1 | |
| . . . | . . . | . . . |
| sₘ₋₄ | STA6 | w_{md}(n) |
| sₘ₋₃ | AP2 | |
| sₘ₋₂ | AP2 | |
| sₘ₋₁ | STA6 | |
| sₘ | STA5 | |

In the example of Table 1, STA1 may be sensing transmitter 504-1, STA2 may be sensing transmitter 504-2, STA5 may be sensing transmitter 504-5, STA6 may be sensing transmitter 504-6, AP1 may be sensing receiver 502-1, and AP2 may be sensing receiver 502-2, for example in the context of a trigger-based (TB) sensing session. In an example, STA1 may be sensing receiver 502-1, STA2 may be sensing receiver 502-2, STA5 may be sensing receiver 502-5, STA6 may be sensing receiver 502-6, AP1 may be sensing transmitter 504-1, and AP2 may be sensing transmitter 504-2, for example in the context of a non-trigger-based (non-TB) sensing session.

In the example shown in Table 1, a motion detection window of length w_{md}=5 is shown. In an example, the length of the motion detection window may be predefined. In some examples, the length of the motion detection window may be configurable for example responsive to feedback of physical network determination agent 562. In an example, the length of the motion detection window (e.g., the number of sampling instances included in the motion detection window) may be tuned or ranged from a small size (or number of sampling instances) to increasing larger sizes (e.g., including greater number of sampling instances) until one or more criteria are reached. For example, if the length or number of sampling instances included in the motion detection window is too small, there may be insufficient motion detection windows that include any network pairs. If the number or percentage of motion detection windows that include one or more network pairs is too small, the length of the motion detection window may be tuned to an increased size, for example until a threshold number or percentage is reached. With this increased size of the motion detection window, there may be a sufficient number of motion detection windows each including at least one network pair to make a proximity topology determination over one or more analysis periods or filtering windows. One example of a criteria is if, for a given motion detection window size, the percentage or the number of motion detection windows each including at least one network pair in the number of all the motion detection windows over an analysis period or a filtering window reaches a percentage threshold (for example, 60%), then the size of the motion detection window is a suitable size. In examples, this percentage or number threshold may be configured by a system administrator. In examples, a starting percentage or number threshold may be configured by a system administrator, and a tuning or ranging process may be performed by physical network determination agent 562 to determine a suitable motion detection window size. Other examples of criteria that may be used to determine a suitable motion detection window size include a number of successive motion detection windows with a network pair in an analysis period or a filtering window; a number, successive number or percentage of motion detection windows in which a motion was detected in an analysis period or a filtering window; and/or a number, successive number or percentage of motion detection windows in which a motion was detected and a network pair was determined.

In the example of Table 1, successive motion detection windows are denoted as w_{md}(1), w_{md}(2), . . . , w_{md}(n). Each motion detection window covers its length (for example, 5) of locating sampling instances (for example, s₁ to s₅). In examples, an analysis period may be defined as a period of time that includes a number of motion detection windows. In an example, the analysis period may include a single motion detection window. In examples, the number of motion detection windows in the analysis period may be configurable. In an example, a system administrator may configure the number of motion detection windows in an analysis period. In an example, the number of motion detection windows in an analysis period may be tuned or ranged from a small number to increasing larger numbers until one or more criteria are reached. For example, if the number of motion detection windows included in the analysis period is too small, there may be insufficient motion detection windows that include network pairs to make a proximity topology determination. If the number of motion detection windows in an analysis period that include network pairs is too small, the analysis period may be tuned to an increased size, for example until a threshold number or percentage is reached. One example of a criteria is if, for an analysis period size, the percentage or number of motion detection windows each including at least one network pair of all the motion detection windows over the analysis period reaches a percentage threshold (for example, 60%), then the size of the motion detection window is a suitable size. In examples, a system administrator may configure this percentage or number threshold. In examples, a starting percentage or number threshold may be configured by a system administrator, and a tuning or ranging process may be performed by physical network determination agent 562 to determine a suitable analysis period size. Other examples of criteria that may be used to determine a suitable analysis period size include a number of successive motion detection windows with a network pair in an analysis period or a filtering window; a number, successive number or percentage of motion detection windows in which a motion was detected in an analysis period or a filtering window; and/or a number, successive number or percentage of motion detection windows in which a motion was detected and a network pair was determined.

In an implementation, physical network determination agent 562 may be configured to determine the physical proximity of access points and stations in the Wi-Fi network based on information from locating sampling instances determined by localizer 560. According to an implementation, in an analysis period including a plurality of motion detection windows that each includes a plurality of locating sampling instances, physical network determination agent 562 may identify, for the plurality of locating sampling instances, a corresponding plurality of network devices closest to a motion, from the plurality of stations and the plurality of access points. Further, for each motion detection window, physical network determination agent 562 may identify a plurality of network pairs, each network pair including one station and one access point from the plurality of network devices. According to some implementations, for the analysis period, physical network determination agent 562 may perform a summation of a number of occurrences of each of the plurality of network pairs (as described below). Subsequently, physical network determination agent 562 may designate, as a proximal network pair, a selected network pair having a largest number of occurrences from among the plurality of network pairs that share a station.

In an implementation, the network device closest to a motion at a locating sampling instance may be denoted by an identifier. The identifiers of the network devices may be stored in identifiers storage 566 as a locating sampling series for each motion detection window. In an example, a network pair (i, j) may be determined if the identifier for the station i and the identifier for the access point j are both represented within a motion detection window. In examples, the network pair (i, j) may be created based on the identification of a closest motion by localizer 560 and is not limited to the access point and station that form a communication link. In an example, the network pair occurrence number may be the number of sampling windows during the analysis period which includes network pair (i, j). For example, based on Table 1, the network pairs are described in Table 2 as below.

TABLE 2
An example of the network pairs

| Motion | | Network Pair |
|---|---|---|
| Detection Window | Network Pair | Occurrence Number |
| w_{md}(1) | (STA1, AP1) | 1 |
| w_{md}(1) | (STA2, AP1) | 1 |
| w_{md}(2) | (STA1, AP1) | 2 |
| . . . | . . . | . . . |
| w_{md}(n) | (STA6, AP2) | 1 |
| w_{md}(n) | (STA5, AP2) | 1 |

As shown in Table 2, motion detection window w_{md}(1) includes network pairs (STA1, AP1) and (STA2, AP1). Motion detection window w_{md}(2) includes network pair (STA1, AP1), which increases the network pair occurrence number for network pair (STA1, AP1) from 1 to 2. Further, motion detection window w_{md}(n) includes network pairs (STA6, AP2) and (STA5, AP2).

In examples, at the end of each analysis period, the network pair occurrence number for each network pair (i, j) may be determined. In an implementation, physical network determination agent 562 may analyze each combination of network pairs (i, j) that includes a single station. For example, as shown in Table 2, for the single station STA1, there are two valid network pairs: (STA1, AP1) and (STA1, AP2).

According to an implementation, physical network determination agent 562 may determine the largest network pair occurrence number for each station. Further, physical network determination agent 562 may determine the network pair with the largest network pair occurrence number representing the proximity link between the station and the closest access point. In examples, a station may have a proximity link with a largest network pair occurrence number and a closest access point over an analysis period. In examples, the station may have a different proximity link with a different largest network pair occurrence number and a different closest access point over a different analysis period.

Table 3 shows an example of network pair occurrence number of a single motion. In the example of Table 3, the analysis period includes 10 motion detection windows.

TABLE 3
An example of network pair occurrence number of a single motion

| | | | Network Pair | Largest Network |
|---|---|---|---|---|
| | Access | | Occurrence | Pair Occurrence |
| Station | Point | Network Pair | Number | Number |
| STA1 | AP1 | (STA1, AP1) | 10 | Y |
| STA2 | AP1 | (STA2, AP1) | 10 | Y |
| STA3 | AP1 | (STA3, AP1) | 0 | N |
| STA4 | AP1 | (STA4, AP1) | 0 | N |
| STA5 | AP1 | (STA5, AP1) | 0 | N |
| STA6 | AP1 | (STA6, AP1) | 3 | N |
| STA7 | AP1 | (STA7, AP1) | 10 | Y |
| STA1 | AP2 | (STA1, AP2) | 0 | N |
| STA2 | AP2 | (STA2, AP2) | 0 | N |
| STA3 | AP2 | (STA3, AP2) | 5 | Y |
| STA4 | AP2 | (STA4, AP2) | 0 | N |
| STA5 | AP2 | (STA5, AP2) | 0 | N |
| STA6 | AP2 | (STA6, AP2) | 7 | Y |
| STA7 | AP2 | (STA7, AP2) | 2 | N |

According to an implementation, physical network determination agent 562 may determine the proximity link for each station based on the largest network pair occurrence number. In the example of Table 3, STA6 is determined to be closer to AP2 than to AP1 based on the largest network pair occurrence number (i.e., 10), meaning that there is a proximity link between STA6 and AP2. In some scenarios, the network pair occurrence number may be zero for all network pair combinations of a station. In such scenarios, physical network determination agent 562 may not make any determination of a proximity link between any network pair including the station.

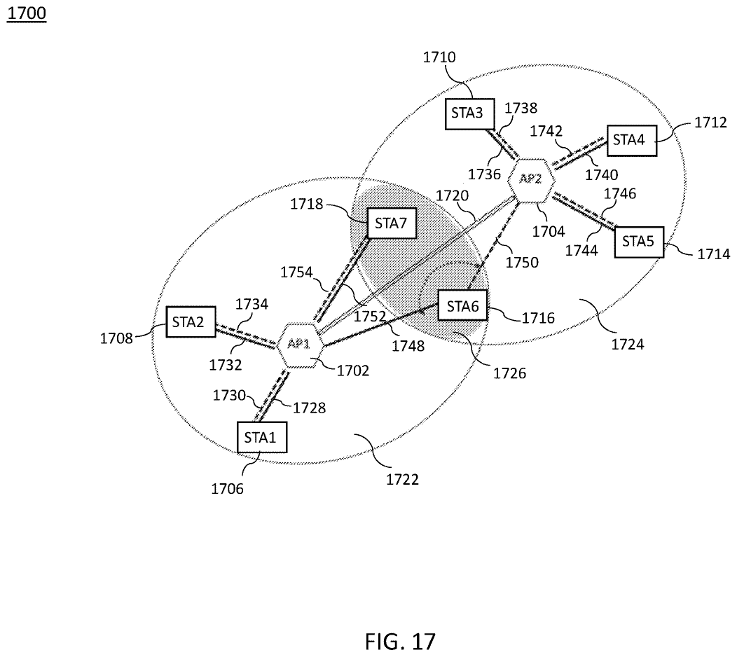

FIG. 17 depicts example 1700 of Wi-Fi network including communications links and proximity links as determined by physical network determination agent 562, according to some embodiments.

In the example of FIG. 17, the Wi-Fi network includes two access points including AP1 1702 and AP2 1704, and seven stations (non-AP STAs) including STA1 1706, STA2 1708, STA3 1710, STA4 1712, STA5 1714, STA6 1716, and STA7 1718. In examples, STA1 1706, STA2 1708, STA3 1710, STA4 1712, STA5 1714, STA6 1716, and STA7 1718 may be connected wirelessly to AP1 1702 or AP2 1704. Further, AP1 1702 and AP2 1704 may be connected with each other via backhaul link 1720. FIG. 17 further shows a coverage area of AP1 1702 (represented by reference number “1722”) and a coverage area of AP2 1704 (represented by reference number “1724”). Also, there is an overlapping coverage area (represented by reference number “1726”) of coverage area of AP1 1702 and coverage area of AP2 1704.

In the example of FIG. 17, a station in a non-overlapping coverage area has the same communication link (represented by a solid line) and proximity link (represented by a dashed line). For example, STA1 1706 has a communication link with AP1 1702 (represented by reference number “1728”) and STA1 1706 also has a proximity link with AP1 1702 (represented by reference number “1730”). STA2 1708 has a communication link with AP1 1702 (represented by reference number “1732”) and STA2 1708 also has a proximity link with AP1 1702 (represented by reference number “1734”). STA3 1710 has a communication link with AP2 1704 (represented by reference number “1736”) and STA3 1710 also has a proximity link with AP2 1704 (represented by reference number “1738”). STA4 1712 has a communication link with AP2 1704 (represented by reference number “1740”) and STA4 1712 also has a proximity link with AP2 1704 (represented by reference number “1742”). STA5 1714 has a communication link with AP2 1704 (represented by reference number “1744”) and STA5 1714 also has a proximity link with AP2 1704 (represented by reference number “1746”).

Furthermore, STA7 1718 has a communication link 1752 with AP1 1702 and a proximity link 1754 also with AP1 1702. However, STA6 1716 has a communication link 1748 with AP1 1702 while it has a proximity link 1750 with AP2 1704. In an example, STA6 1716 may be determined to be in an overlapping coverage area.

In an implementation, physical network determination agent 562 may identify an overlapping coverage area defined by selected ones of the plurality of stations having non-corresponding communication links and proximity links. According to an implementation, physical network determination agent 562 may identify an overlap ratio based on the proximity link topology and the communication link topology. In examples, the overlap ratio may be defined as a ratio between a first number of selected ones of the plurality of stations having non-corresponding communication links and proximity links and a second number of the plurality of stations in the sensing space. In some examples, the overlap ratio may be defined as a ratio between a number of stations in an overlapping coverage area and the total number of stations in the sensing space. In an example, physical network determination agent 562 may identify the overlap ratio using Equation (9) provided below.

$$Overlap ratio = \frac{Number of stations in the overlapping coverage area}{Total number of stations in the sensing space} \qquad ( 9 )$$

In an implementation, Wi-Fi network coordination agent 564 may be configured to identify one or more Wi-Fi network adjustments based on the overlap ratio. In examples, Wi-Fi network coordination agent 564 may identify a Wi-Fi network adjustment based on the overlap ratio exceeding an overlap ratio threshold. In an example, if the overlap ratio is higher than the overlap ratio threshold, then the Wi-Fi network coordination agent 564 may determine that the overlapping coverage area is significant enough that interference may be an issue in the Wi-Fi network. In an example, a value of the overlap ratio threshold may be 30 percent. In examples, the overlap ratio threshold may be predetermined or may be configured by the system administrator. In examples, Wi-Fi network coordination agent 564 may determine a suitable overlap ratio threshold, for example using measurements obtained from network devices. In examples, such measurements may include signal to noise ratio (SNR), signal to interference plus noise ratio (SINR), reference signal received power (RSRP), reference signal received quality (RSRQ), bit error rate (BER), block error rate (BLER), frame error rate (FER), and other metrics used to measure network performance.

Referring to FIG. 17, in an implementation, if the overlap ratio is higher than the overlap ratio threshold (e.g., greater than 30 percent), then it may be concluded that the overlapping coverage area existing between AP1 and AP2 may be significant enough that interference may be an issue between the basic service set (BSS) of AP1 and the BSS of AP2. In an example, if it is determined that the overlapping coverage area existing between AP1 and AP2 may be significant enough that interference may occur, then Wi-Fi network coordination agent 564 may take an appropriate action to mitigate or reduce the interference.

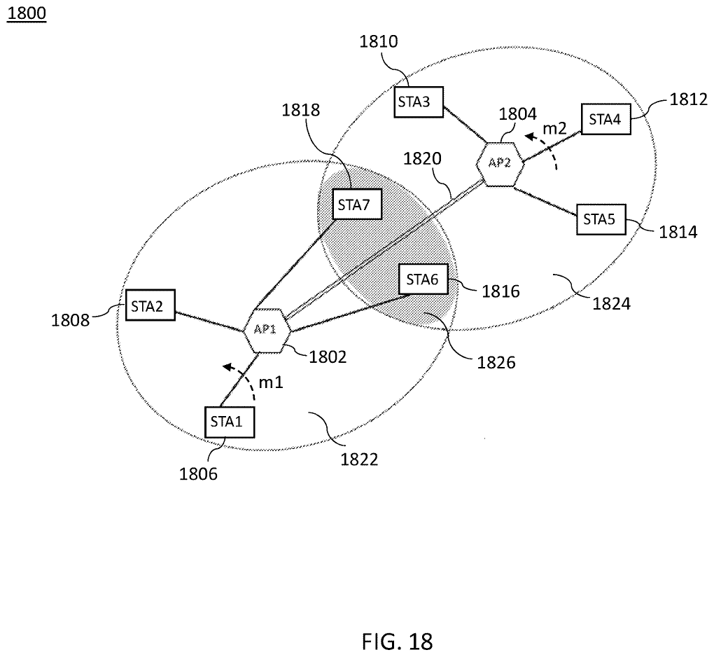

In a Wi-Fi network, at any time, there may be more than one motion taking place. In an example, there are two motions (for example, m₁ and m₂) in a Wi-Fi network in the same motion detection window. FIG. 18 depicts example 1800 of two motions in the same motion detection window within a Wi-Fi network, according to some embodiments.

In the example of FIG. 18, the Wi-Fi network includes two access points including AP1 1802 and AP2 1804, and seven stations (non-AP STAs) including STA1 1806, STA2 1808, STA3 1810, STA4 1812, STA5 1814, STA6 1816, and STA7 1818. In examples, STA1 1806, STA2 1808, STA3 1810, STA4 1812, STA5 1814, STA6 1816, and STA7 1818 may have communication links with AP1 1802 or AP2 1804. Further, AP1 1802 and AP2 1804 may be connected with each other via backhaul link 1820. FIG. 18 further shows a coverage area of AP1 1802 (represented by reference number “1822”) and a coverage area of AP2 1804 (represented by reference number “1824”). Also, there is an overlapping coverage area of coverage area (represented by reference number “1826”) of AP1 1802 and coverage area of AP2 1804. In the example shown in FIG. 18, there exists motion m₁ between STA1 1806 and AP1 1802. Further, motion m₂ exists between STA4 1812 and AP2 1804.

In scenarios where two motions exist in the same locating sampling instance or motion detection window period, localizer 560 may determine a single closest network device to motion. In an example, at locating sampling instance s₁, there may be motion m₁ and m₂. If the distance between STA1 1806 and motion m₁ is determined to be shorter than the distance between STA4 1812 and motion m₂, then STA1 1806 may be determined to be the closest network device at locating sampling instance $1. In some examples, at the locating sampling instance s₂, there may be motion m₁ and m₂. If the distance between STA4 1812 and motion m₂ is determined to be shorter than the distance between STA1 1806 and motion m₁, then STA4 1812 may be determined to be the closest network device at locating sampling instance s₂. An example of the closest network devices of two motions m₁ and m₂ is described in Table 4 provided below.

TABLE 4
An example of the closest network devices
of two motions at the same time

| | | | |
|---|---|---|---|
| Locating | Closest | Motion | Analysis |
| Sampling Instance | Network Device | Detection Window | Period |

| | | |
|---|---|---|
| s₁ | STA1 | w_{md}(1) |
| s₂ | STA4 | |
| s₃ | STA2 | |
| s₄ | AP1 | |
| s₅ | STA2 | |
| s₆ | STA1 | w_{md}(2) |
| s₇ | AP1 | |
| s₈ | STA4 | |
| s₉ | AP1 | |
| s₁₀ | AP1 | |
| . . . | . . . | . . . |
| sₘ₋₄ | STA6 | w_{md}(n) |
| sₘ₋₃ | AP2 | |
| sₘ₋₂ | AP2 | |
| sₘ₋₁ | STA6 | |
| sₘ | STA5 | |

In an example, based on Table 4, the network pairs may be described in Table 5 provided below.

TABLE 5
An example of the network pairs of two motions at the same time

| Motion | | Network Pair |
|---|---|---|
| Detection Window | Network Pair | Occurrence Number |
| w_{md}(1) | (STA1, AP1) | 1 |
| w_{md}(1) | (STA2, AP1) | 1 |
| w_{md}(1) | (STA4, AP1) | 1 |
| w_{md}(2) | (STA1, AP1) | 2 |
| w_{md}(2) | (STA4, AP1) | 2 |
| . . . | . . . | . . . |
| w_{md}(n) | (STA6, AP2) | 1 |
| w_{md}(n) | (STA5, AP2) | 1 |

In situations where multiple motions exist in the Wi-Fi sensing system, based on FIG. 18 and Table 5, there may be correct network pairs and incorrect network pairs. Based on the data described in Table 5, an incorrect network pair between AP1 and STA4 has been made due to aggregation of the detection of motions m₁ and m₂. Since a determination of an incorrect network pair requires alignment of two independent motions in the Wi-Fi sensing system, it may be assumed that such an alignment is uncommon, and it may also be assumed that the correct network pair occurrence number is much larger than the incorrect network pair occurrence number for most localizing situations. For example, based on Table 5 and Equation (9), the network pair may be listed in Table 6 provided below.

TABLE 6
An example of network pair occurrence
number of two motions at the same time

| | | | Network Pair | Largest Network |
|---|---|---|---|---|
| | Access | | Occurrence | Pair Occurrence |
| Station | Point | Network Pair | Number | Number |
| STA1 | AP1 | (STA1, AP1) | 20 | Y |
| STA2 | AP1 | (STA2, AP1) | 10 | Y |
| STA3 | AP1 | (STA3, AP1) | 2 | N |
| STA4 | AP1 | (STA4, AP1) | 2 | N |
| STA5 | AP1 | (STA5, AP1) | 2 | N |
| STA6 | AP1 | (STA6, AP1) | 8 | N |
| STA7 | AP1 | (STA7, AP1) | 8 | N |
| STA1 | AP2 | (STA1, AP2) | 2 | N |
| STA2 | AP2 | (STA2, AP2) | 2 | N |
| STA3 | AP2 | (STA3, AP2) | 8 | Y |
| STA4 | AP2 | (STA4, AP2) | 8 | Y |
| STA5 | AP2 | (STA5, AP2) | 8 | Y |
| STA6 | AP2 | (STA6, AP2) | 11 | Y |
| STA7 | AP2 | (STA7, AP2) | 9 | Y |

In examples, given the tendency for correct network pairs to dominate incorrect network pairs, the correct network pairs should be detected while the incorrect network pairs should be filtered out. In an implementation, the length of the analysis period may be increased to improve the correct network pair detection rate (and reduce the likelihood of determination of incorrect network pairs). However, too large of an increase to the analysis period may result in a slow system performance in the determination of overlapping coverage areas. As a consequence, Wi-Fi sensing system (system 500) may be slow to perform determination of Wi-Fi system topology (i.e., proximity link topology and the communication link topology) and slow to respond to changes in Wi-Fi system topology. To mitigate slow system performance, a cascaded filter system may be implemented.

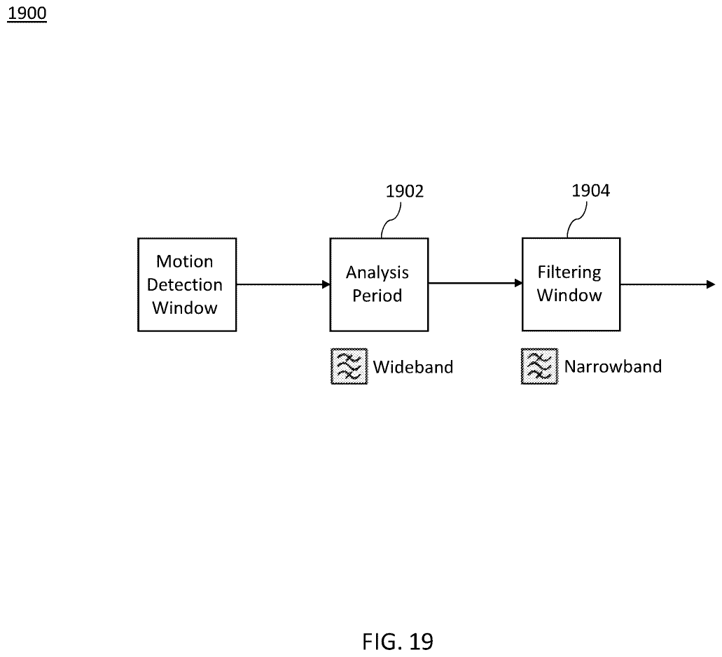

FIG. 19 depicts cascaded filter system 1900, according to some embodiments. In cascaded filter system 1900, a first filter may be provided by the analysis period (represented by reference number “1902”). In cascaded filter system 1900, the analysis period may be chosen to provide mitigation of incorrect network pairs. However, a requirement of the choice of length of the analysis period is to provide an acceptable response time. In an example, a system administrator may determine an acceptable response time and the length of the analysis period may be configured based on the acceptable response time. Further, a second filter may be provided by a filtering window 1904. The filtering window may combine results from successive analysis periods to further suppress the influence of incorrect network pairs. In an example, the filtering window may be longer than the analysis period and may combine (filter) many successive network pairs determinations. In an implementation, a sliding filtering window may be used (for example, providing for a moving average) whereby at each successive epoch of the sliding filtering window, one new determination of network pairs is added, and one old determination of network pairs is removed. In some examples, the filtering window may be equal to the analysis period and cascaded filter system 1900 may become equivalent to a simple filter system. In an example, the length of the filtering window may be configured to optimize system performance in terms of rate of detection of incorrect network pairs.

According to an implementation, for a filtering window including the analysis period and a plurality of additional analysis periods, physical network determination agent 562 may perform summation of a number of occurrences of each of the plurality of network pairs in the filtering window. Further, physical network determination agent 562 may redesignate a new selected one of the plurality of network pairs having a largest number of occurrences from among the plurality of network pairs that share a station as the proximal network pair for a different filter window.

According to an implementation, after proximity links are detected and one or more overlapping coverage areas are determined, Wi-Fi network coordination agent 564 may use this information to improve the communication performance of system 500. In an implementation, Wi-Fi network coordination agent 564 may identify one or more Wi-Fi network adjustments. In examples, a Wi-Fi network adjustment includes at least one of a frequency band change, a modulating coding scheme change, a transmission power reduction, a beamforming adjustment, and a network parameter change.

In an implementation, Wi-Fi network coordination agent 564 may make changes to the Wi-Fi network where it has the ability. In some implementations, Wi-Fi network coordination agent 564 may make recommendations of changes (for example, to one or more access points in the Wi-Fi network. In examples, Wi-Fi network coordination agent 564 may make changes or recommendations of changes to the configuration of one or more aspects of the Wi-Fi network. In an implementation, after one or more changes are made to the configuration of one or more aspects of the Wi-Fi network, Wi-Fi sensing system may determine a new proximity topology and may determine one or more overlapping coverage areas in the changed Wi-Fi network. In examples, differences between the one or more overlapping coverage areas before changes to the Wi-Fi network and one or more overlapping coverage areas after the changes to the Wi-Fi network may be used to determine, change, update or tune one or more thresholds or criteria of system 500 to tend to an optimized system 500.

According to an implementation, Wi-Fi network coordination agent 564 may reduce or minimize physical BSS coverage by reducing the transmission power of one or more access points in the Wi-Fi system. For example, if physical network determination agent 562 determines that there are a group of stations with proximity links to one access point but with communication links to a second access point (i.e., they are in an overlapping coverage area), then Wi-Fi network coordination agent 564 may reduce (or recommend to reduce) the transmission power of the second access point be reduced to reduce the overlapping coverage area.

In some implementations, Wi-Fi network coordination agent 564 may be configured with the location of the devices in the Wi-Fi network (for example, static or semi-static devices such as access points, smart switches/sockets/IoT devices, TVs, gaming consoles, smart speakers, etc.). In examples, the location of a station may be determined by combining distance information from localizer 560 and physical network determination agent 562, and angle-of-arrival or direction information of a received signal from another network element. In an implementation, Wi-Fi network coordination agent 564 may combine the location of devices in an overlapping coverage area with the overlap ratio to define an area of network coverage for each access point in the Wi-Fi network. In an example, Wi-Fi network coordination agent 564 may recommend an area of coverage which uses beamforming or beamsteering on the access point. The recommended area of coverage may be non-uniform and the non-uniform coverage area for each access point may minimize the overlapping coverage area. In some examples, Wi-Fi network coordination agent 564 may recommend a change in frequency band or other modulation coding scheme elements for an access point or station which is in an overlapping coverage area. In certain situations, because of environmental effects in the coverage area of the Wi-Fi system, a station in an overlapping coverage area may not be able to connect to its closest access point. However, a change in the frequency band or modulating coding scheme may allow the station to connect to its closest access point. For example, a station may be physically close to an access point, however, if the radio frequency (RF) path is complex then received signal strength indicator (RSSI) received by the station may be low. In this example, a change to a different frequency band (for example, from 2.4 GHz to 5 GHZ) may be more suitable than beamsteering the station to a different access point, as the different frequency band may have different RF propagation effects.

In examples where it may not be possible to reduce an overlapping coverage area, Wi-Fi network coordination agent 564 may configure or control (or make recommendations to configure or control) Wi-Fi network parameters which may improve performance in an interfering environment (such as to change the size of MAC Protocol Data Unit (MPDU) and/or to optimize overhead). For example, Wi-Fi network coordination agent 564 may recommend an access point decrease the size of the MPDU for situations in which interference due to an overlapping coverage area may cause a lot of re-transmissions (re-transmissions may use a different size of MPDU). In some examples, Wi-Fi network coordination agent 564 may recommend an access point increase the size of the MPDU for situations in which the stations are physically close to the access point and the BSS coverage is small (for example, to optimize or decrease the overhead of MPDU).

According to an implementation, upon identifying one or more Wi-Fi network adjustments, Wi-Fi network coordination agent 564 may transmit the one or more Wi-Fi network adjustments to one or more selected access points from the plurality of access points. In an implementation, the selected one or more access points may perform one or more actions based on the one or more Wi-Fi network adjustments received from Wi-Fi network coordination agent 564. In an example, Wi-Fi network coordination agent 564 may select one or more access points from the plurality of access points. Wi-Fi network coordination agent 564 may then transmit the one or more Wi-Fi network adjustments to one or more selected access points from the plurality of access points. In some implementations, Wi-Fi network coordination agent 564 may determine one or more new overlapping coverage areas and/or a new overlap ratio subsequent to transmitting one or more Wi-Fi network adjustments.

FIG. 20A and FIG. 20B depict flowchart 2000 for performing Wi-Fi network evaluation to identify a Wi-Fi network adjustment, according to some embodiments. In an implementation, flowchart 2000 is carried out by a networking device operating within a Wi-Fi network including a plurality of access points and plurality of stations. In an example, the networking device may be remote processing device 506, plurality of access points may be plurality of sensing receivers 502-(1-M) or sensing transmitters 504-(1-N), and plurality of stations may be plurality of sensing transmitters 504-(1-N) or sensing receivers 502-(1-M). Further, the Wi-Fi network may be network 580.

In a brief overview of an implementation of flowchart 2000, at step 2002, a communication link topology of a Wi-Fi network may be identified. The communication link topology may be defined by a plurality of communication links, each communication link being between an associated pair from a plurality of stations and a plurality of access points. At step 2004, a plurality of sensing measurements measured according to the communication link topology may be received. At step 2006, a proximity link topology of the Wi-Fi network may be determined based on the plurality of sensing measurements. The proximity link topology may be defined by a plurality of proximity links, each proximity link being between a proximal network pair from a plurality of network pairs from the plurality of stations and the plurality of access points. At step 2008, an overlap ratio may be identified based on the proximity link topology and the communication link topology. At step 2010, a Wi-Fi network adjustment may be identified based on the overlap ratio.

Step 2002 includes identifying a communication link topology of a Wi-Fi network, the communication link topology being defined by a plurality of communication links, each communication link being between an associated pair from a plurality of stations and a plurality of access points. According to an implementation, remote processing device 506 may be configured to identify the communication link topology of the Wi-Fi network.

Step 2004 includes receiving a plurality of sensing measurements measured according to the communication link topology. According to an implementation, remote processing device 506 may be configured to receive the plurality of sensing measurements measured according to the communication link topology. In examples, remote processing device 506 may receive the plurality of sensing measurements from one or more of plurality of sensing receivers 502-(1-M). In an example, the sensing receivers 502-(1-M) may be access points in a trigger-based (TB) sensing session. In an example, remote processing device 506 may receive the plurality of sensing measurements from one or more of plurality of sensing transmitters 504-(1-N). In an example, the sensing transmitters 504-(1-N) may be access points in a non-trigger-based (non-TB) sensing session.

Step 2006 includes determining a proximity link topology of the Wi-Fi network based on the plurality of sensing measurements, the proximity link topology being defined by a plurality of proximity links, each proximity link being between a proximal network pair from a plurality of network pairs from the plurality of stations and the plurality of access points. According to an implementation, remote processing device 506 may be configured to determine the proximity link topology of the Wi-Fi network based on the plurality of sensing measurements. According to an implementation, remote processing device 506 may be configured to identify an overlapping coverage area defined by selected ones of the plurality of stations having non-corresponding communication links and proximity links.

Step 2008 includes identifying an overlap ratio based on the proximity link topology and the communication link topology. According to an implementation, remote processing device 506 may be configured to identify the overlap ratio based on the proximity link topology and the communication link topology. In an example, remote processing device 506 may be configured to identify the overlap ratio using Equation (9) described earlier. In an example, the overlap ratio may be defined as a ratio between a first number of selected ones of the plurality of stations having non-corresponding communication links and proximity links and a second number of the plurality of stations.

Step 2010 includes identifying a Wi-Fi network adjustment based on the overlap ratio. According to an implementation, remote processing device 506 may be configured to identify the Wi-Fi network adjustment based on the overlap ratio. In examples, the Wi-Fi network adjustment includes at least one of a frequency band change, a modulating coding scheme change, a transmission power reduction, a beamforming adjustment, and a network parameter change.

FIG. 21A and FIG. 21B depict flowchart 2100 for performing Wi-Fi network evaluation to identify a Wi-Fi network adjustment and transmit the Wi-Fi network adjustment to one or more selected access points, according to some embodiments. In an implementation, flowchart 2100 is carried out by a networking device operating within a Wi-Fi network including a plurality of access points and a plurality of stations. In an example, the networking device may be remote processing device 506, plurality of access points may be plurality of sensing receivers 502-(1-M) or sensing transmitters 504-(1-N), and plurality of stations may be plurality of sensing transmitters 504-(1-N) or sensing receivers 502-(1-M). Further, Wi-Fi network may be network 580.

In a brief overview of an implementation of flowchart 2100, at step 2102, a communication link topology of a Wi-Fi network may be identified. The communication link topology may be defined by a plurality of communication links, each communication link being between an associated pair from a plurality of stations and a plurality of access points. At step 2104, a plurality of sensing measurements measured according to the communication link topology may be received. At step 2106, a proximity link topology of the Wi-Fi network may be determined based on the plurality of sensing measurements. The proximity link topology may be defined by a plurality of proximity links, each proximity link being between a proximal network pair from a plurality of network pairs from the plurality of stations and the plurality of access points. At step 2108, an overlap ratio may be identified based on the proximity link topology and the communication link topology. At step 2110, a Wi-Fi network adjustment may be identified based on the overlap ratio exceeding an overlap ratio threshold. At step 2112, the Wi-Fi network adjustment may be transmitted to one or more selected access points from the plurality of access points. At step 2114, a new overlap ratio may be determined subsequent to transmitting the Wi-Fi network adjustment.

Step 2102 includes identifying a communication link topology of a Wi-Fi network, the communication link topology being defined by a plurality of communication links, each communication link being between an associated pair from a plurality of stations and a plurality of access points. According to an implementation, remote processing device 506 may be configured to identify the communication link topology of the Wi-Fi network.

Step 2104 includes receiving a plurality of sensing measurements measured according to the communication link topology. According to an implementation, remote processing device 506 may be configured to receive the plurality of sensing measurements measured according to the communication link topology. In examples, remote processing device 506 may receive the plurality of sensing measurements from one or more of plurality of sensing receivers 502-(1-M). In an example, the sensing receivers 502-(1-M) may be access points in a trigger-based (TB) sensing session. In an example, remote processing device 506 may receive the plurality of sensing measurements from one or more of plurality of sensing transmitters 504-(1-N). In an example, the sensing transmitters 504-(1-N) may be access points in a non-trigger-based (non-TB) sensing session.

Step 2106 includes determining a proximity link topology of the Wi-Fi network based on the plurality of sensing measurements, the proximity link topology being defined by a plurality of proximity links, each proximity link being between a proximal network pair from a plurality of network pairs from the plurality of stations and the plurality of access points. According to an implementation, remote processing device 506 may be configured to determine the proximity link topology of the Wi-Fi network based on the plurality of sensing measurements. According to an implementation, remote processing device 506 may be configured to identify an overlapping coverage area defined by selected ones of the plurality of stations having non-corresponding communication links and proximity links.

Step 2108 includes identifying an overlap ratio based on the proximity link topology and the communication link topology. According to an implementation, remote processing device 506 may be configured to identify the overlap ratio based on the proximity link topology and the communication link topology. In an example, remote processing device 506 may be configured to identify the overlap ratio using Equation (9) described earlier. In an example, the overlap ratio may be defined as a ratio between a first number of selected ones of the plurality of stations having non-corresponding communication links and proximity links and a second number of the plurality of stations.

Step 2110 includes identifying a Wi-Fi network adjustment based on the overlap ratio exceeding an overlap ratio threshold. According to an implementation, remote processing device 506 may be configured to identify the Wi-Fi network adjustment based on the overlap ratio exceeding the overlap ratio threshold. In examples, the Wi-Fi network adjustment includes at least one of a frequency band change, a modulating coding scheme change, a transmission power reduction, a beamforming adjustment, and a network parameter change.

Step 2112 includes transmitting the Wi-Fi network adjustment to one or more selected access points from the plurality of access points. According to an implementation, remote processing device 506 may be configured to transmit the Wi-Fi network adjustment to one or more selected access points from the plurality of access points.

Step 2114 includes determining a new overlap ratio subsequent to transmitting the Wi-Fi network adjustment. According to an implementation, remote processing device 506 may be configured to determine the new overlap ratio subsequent to transmitting the Wi-Fi network adjustment.

FIG. 22A, FIG. 22B, and FIG. 22C depict flowchart 2200 for performing Wi-Fi network evaluation to identify a Wi-Fi network adjustment, according to some embodiments.

In an implementation, flowchart 2200 is carried out by a networking device operating within a Wi-Fi network including a plurality of access points and plurality of stations. In an example, the networking device may be remote processing device 506, plurality of access points may be plurality of sensing receivers 502-(1-M) or sensing transmitters 504-(1-N), and plurality of stations may be plurality of sensing transmitters 504-(1-N) or sensing receivers 502-(1-M). Further, the Wi-Fi network may be network 580.

In a brief overview of an implementation of flowchart 2200, at step 2202, a communication link topology of a Wi-Fi network may be identified. The communication link topology may be defined by a plurality of communication links, each communication link being between an associated pair from a plurality of stations and a plurality of access points. At step 2204, a plurality of sensing measurements measured according to the communication link topology may be received. At step 2206, in an analysis period including a plurality of motion detection windows that each includes a plurality of locating sampling instances, for the plurality of locating sampling instances, a corresponding plurality of network devices closest to a motion from the plurality of stations and the plurality of access points may be identified. At step 2208, for each motion detection window, a plurality of network pairs, each network pair including one station and one access point from the plurality of network devices may be identified. At step 2210, for the analysis period, a number of occurrences of each of the plurality of network pairs may be summed. At step 2212, a selected one of the plurality of network pairs having a largest number of occurrences from among the plurality of network pairs that share a station may be designated as a proximal network pair. At step 2214, a proximity link topology of the Wi-Fi network may be determined based on the plurality of sensing measurements. The proximity link topology may be defined by a plurality of proximity links, each proximity link being between a proximal network pair from a plurality of network pairs from the plurality of stations and the plurality of access points. At step 2216, an overlap ratio may be identified based on the proximity link topology and the communication link topology. At step 2218, a Wi-Fi network adjustment may be identified based on the overlap ratio.

Step 2202 includes identifying a communication link topology of a Wi-Fi network, the communication link topology being defined by a plurality of communication links, each communication link being between an associated pair from a plurality of stations and a plurality of access points. According to an implementation, remote processing device 506 may be configured to identify the communication link topology of the Wi-Fi network.

Step 2204 includes receiving a plurality of sensing measurements measured according to the communication link topology. According to an implementation, remote processing device 506 may be configured to receive the plurality of sensing measurements measured according to the communication link topology. In examples, remote processing device 506 may receive the plurality of sensing measurements from one or more of plurality of sensing receivers 502-(1-M). In an example, the sensing receivers 502-(1-M) may be access points in a trigger-based (TB) sensing session. In an example, remote processing device 506 may receive the plurality of sensing measurements from one or more of plurality of sensing transmitters 504-(1-N). In an example, the sensing transmitters 504-(1-N) may be access points in a non-trigger-based (non-TB) sensing session.

Step 2206 includes in an analysis period including a plurality of motion detection windows that each includes a plurality of locating sampling instances, identifying, for the plurality of locating sampling instances, a corresponding plurality of network devices closest to a motion from the plurality of stations and the plurality of access points. According to an implementation, remote processing device 506 may be configured to, in an analysis period including a plurality of motion detection windows that each includes a plurality of locating sampling instances, identify, for the plurality of locating sampling instances, a corresponding plurality of network devices closest to a motion from the plurality of stations and the plurality of access points.

Step 2208 includes for each motion detection window, identifying a plurality of network pairs, each network pair including one station and one access point from the plurality of network devices. According to an implementation, remote processing device 506 may be configured to, for each motion detection window, identify a plurality of network pairs, each network pair including one station and one access point from the plurality of network devices.

Step 2210 includes for the analysis period, summing a number of occurrences of each of the plurality of network pairs. According to an implementation, remote processing device 506 may be configured to, for the analysis period, perform summation of a number of occurrences of each of the plurality of network pairs.

Step 2212 includes designating, as a proximal network pair, a selected one of the plurality of network pairs having a largest number of occurrences from among the plurality of network pairs that share a station. According to an implementation, remote processing device 506 may be configured to, designate, as a proximal network pair, a selected one of the plurality of network pairs having a largest number of occurrences from among the plurality of network pairs that share a station.

Step 2214 includes determining a proximity link topology of the Wi-Fi network based on the plurality of sensing measurements, the proximity link topology being defined by a plurality of proximity links, each proximity link being between a proximal network pair from a plurality of network pairs from the plurality of stations and the plurality of access points. According to an implementation, remote processing device 506 may be configured to determine the proximity link topology of the Wi-Fi network based on the plurality of sensing measurements. According to an implementation, remote processing device 506 may be configured to identify an overlapping coverage area defined by selected ones of the plurality of stations having non-corresponding communication links and proximity links. In examples, determining the proximity link topology includes identifying the proximal network pair as being between one of the plurality of stations and a corresponding one of the plurality of access points that is a closest access point to the one of the plurality of stations based on at least one of the plurality of sensing measurements. In an example, the at least one of the plurality of sensing measurements may be indicative of a motion in a sensing space associated with the Wi-Fi network. The motion may be selected from a plurality of detected motions as the motion closest to one of the plurality of network devices. According to some implementations, identifying the proximal network pair further includes, for a filtering window including the analysis period and a plurality of additional analysis periods, summing a number of occurrences of each of the plurality of network pairs in the filtering window, and redesignating, as the proximal network pair, a new selected one of the plurality of network pairs having a largest number of occurrences from among the plurality of network pairs that share a station.

Step 2216 includes identifying an overlap ratio based on the proximity link topology and the communication link topology. According to an implementation, remote processing device 506 may be configured to identify the overlap ratio based on the proximity link topology and the communication link topology. In an example, remote processing device 506 may be configured to identify the overlap ratio using Equation (9) described earlier. In an example, the overlap ratio may be defined as a ratio between a first number of selected ones of the plurality of stations having non-corresponding communication links and proximity links and a second number of the plurality of stations.

Step 2218 includes identifying a Wi-Fi network adjustment based on the overlap ratio. According to an implementation, remote processing device 506 may be configured to identify the Wi-Fi network adjustment based on the overlap ratio. In examples, the Wi-Fi network adjustment includes at least one of a frequency band change, a modulating coding scheme change, a transmission power reduction, a beamforming adjustment, and a network parameter change.

Embodiment 1 is a method for Wi-Fi network evaluation carried out by a networking device operating within a Wi-Fi network including a plurality of stations and a plurality of access points, the networking device including at least one processor configured to execute instructions, the method comprising: identifying a communication link topology of the Wi-Fi network, the communication link topology being defined by a plurality of communication links, each communication link being between an associated pair from the plurality of stations and the plurality of access points; receiving, by the networking device, a plurality of sensing measurements measured according to the communication link topology; determining a proximity link topology of the Wi-Fi network based on the plurality of sensing measurements, the proximity link topology being defined by a plurality of proximity links, each proximity link being between a proximal network pair from a plurality of network pairs from the plurality of stations and the plurality of access points; identifying an overlap ratio based on the proximity link topology and the communication link topology; and identifying a Wi-Fi network adjustment based on the overlap ratio.

Embodiment 2 is the method of embodiment 1, wherein determining the proximity link topology includes: identifying the proximal network pair as being between one of the plurality of stations and a corresponding one of the plurality of access points that is a closest access point to the one of the plurality of stations based on at least one of the plurality of sensing measurements.

Embodiment 3 is the method of embodiment 2, wherein the at least one of the plurality of sensing measurements is indicative of a motion in a sensing space associated with the Wi-Fi network.

Embodiment 4 is the method of embodiment 3, wherein identifying the proximal network pair further includes: in an analysis period including a plurality of motion detection windows that each includes a plurality of locating sampling instances, identifying, for the plurality of locating sampling instances, a corresponding plurality of network devices closest to the motion from the plurality of stations and the plurality of access points; for each motion detection window, identifying a plurality of network pairs, each network pair including one station and one access point from the plurality of network devices; for the analysis period, summing a number of occurrences of each of the plurality of network pairs; and designating, as the proximal network pair, a selected one of the plurality of network pairs having a largest number of occurrences from among the plurality of network pairs that share a station.

Embodiment 5 is the method of any of embodiments 2-4, wherein the motion is selected from a plurality of detected motions as the motion closest to one of the plurality of network devices.

Embodiment 6 is the method of any of embodiments 4-5, further comprising: for a filtering window including the analysis period and a plurality of additional analysis periods, summing a number of occurrences of each of the plurality of network pairs in the filtering window; and redesignating, as the proximal network pair, a new selected one of the plurality of network pairs having a largest number of occurrences from among the plurality of network pairs that share a station.

Embodiment 7 is the method of any of embodiments 1-6, further comprising: identifying an overlapping coverage area defined by selected ones of the plurality of stations having non-corresponding communication links and proximity links.

Embodiment 8 is the method of any of embodiments 1-7, wherein the overlap ratio is defined as a ratio between a first number of selected ones of the plurality of stations having non-corresponding communication links and proximity links and a second number of the plurality of stations.

Embodiment 9 is the method of any of embodiments 1-8, wherein identifying the Wi-Fi network adjustment is further based on the overlap ratio exceeding an overlap ratio threshold.

Embodiment 10 is the method of any of embodiments 1-9, wherein the Wi-Fi network adjustment includes at least one of: a frequency band change, a modulating coding scheme change, a transmission power reduction, a beamforming adjustment, and a network parameter change, the method further comprising: transmitting the Wi-Fi network adjustment to one or more selected access points from the plurality of access points.

Embodiment 11 is the method of embodiment 10, further comprising determining a new overlap ratio subsequent to transmitting the Wi-Fi network adjustment.

Embodiment 12 is a system for Wi-Fi network evaluation, comprising a networking device operating within a Wi-Fi network including a plurality of stations and a plurality of access points, the networking device including at least one processor configured to execute instructions for: identifying a communication link topology of the Wi-Fi network, the communication link topology being defined by a plurality of communication links, each communication link being between an associated pair from the plurality of stations and the plurality of access points; receiving, by the networking device, a plurality of sensing measurements measured according to the communication link topology; determining a proximity link topology of the Wi-Fi network based on the plurality of sensing measurements, the proximity link topology being defined by a plurality of proximity links, each proximity link being between a proximal network pair from a plurality of network pairs from the plurality of stations and the plurality of access points; identifying an overlap ratio based on the proximity link topology and the communication link topology; and identifying a Wi-Fi network adjustment based on the overlap ratio.

Embodiment 13 is the system of embodiment 12, wherein determining the proximity link topology includes: identifying the proximal network pair as being between one of the plurality of stations and a corresponding one of the plurality of access points that is a closest access point to the one of the plurality of stations based on at least one of the plurality of sensing measurements.

Embodiment 14 is the system of embodiment 13, wherein the at least one of the plurality of sensing measurements is indicative of a motion in a sensing space associated with the Wi-Fi network.

Embodiment 15 is the system of embodiment 14, wherein identifying the proximal network pair further includes: in an analysis period including a plurality of motion detection windows that each includes a plurality of locating sampling instances, identifying, for the plurality of locating sampling instances, a corresponding plurality of network devices closest to the motion from the plurality of stations and the plurality of access points; for each motion detection window, identifying a plurality of network pairs, each network pair including one station and one access point from the plurality of network devices; for the analysis period, summing a number of occurrences of each of the plurality of network pairs; and designating, as the proximal network pair, a selected one of the plurality of network pairs having a largest number of occurrences from among the plurality of network pairs that share a station.

Embodiment 16 is the system of any of embodiments 13-15, wherein the motion is selected from a plurality of detected motions as the motion closest to one of the plurality of network devices.

Embodiment 17 is the system of any of embodiments 15-16, wherein the at least one processor is further configured for: for a filtering window including the analysis period and a plurality of additional analysis periods, summing a number of occurrences of each of the plurality of network pairs in the filtering window; and redesignating, as the proximal network pair, a new selected one of the plurality of network pairs having a largest number of occurrences from among the plurality of network pairs that share a station.

Embodiment 18 is the system of any of embodiments 12-17, wherein the at least one processor is further configured for: identifying an overlapping coverage area defined by selected ones of the plurality of stations having non-corresponding communication links and proximity links.

Embodiment 19 is the system of any of embodiments 12-18, wherein the overlap ratio is defined as a ratio between a first number of selected ones of the plurality of stations having non-corresponding communication links and proximity links and a second number of the plurality of stations.

Embodiment 20 is the system of any of embodiments 12-19, wherein identifying the Wi-Fi network adjustment is further based on the overlap ratio exceeding an overlap ratio threshold.

Embodiment 21 is the system of any of embodiments 12-20, wherein the Wi-Fi network adjustment includes at least one of: a frequency band change, a modulating coding scheme change, a transmission power reduction, a beamforming adjustment, and a network parameter change, the method further comprising: transmitting the Wi-Fi network adjustment to one or more selected access points from the plurality of access points.

Embodiment 22 is the system of embodiment 21, wherein the at least one processor is further configured for determining a new overlap ratio subsequent to transmitting the Wi-Fi network adjustment.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method for Wi-Fi network evaluation carried out by a networking device operating within a Wi-Fi network including a plurality of stations and a plurality of access points, the networking device including at least one processor configured to execute instructions, the method comprising:
identifying a communication link topology of the Wi-Fi network, the communication link topology being defined by a plurality of communication links, each communication link being between an associated pair from the plurality of stations and the plurality of access points;
receiving, by the networking device, a plurality of sensing measurements measured according to the communication link topology;
determining a proximity link topology of the Wi-Fi network based on the plurality of sensing measurements, the proximity link topology being defined by a plurality of proximity links, each proximity link being between a proximal network pair from a plurality of network pairs from the plurality of stations and the plurality of access points;
identifying an overlap ratio based on the proximity link topology and the communication link topology; and
identifying a Wi-Fi network adjustment based on the overlap ratio.

2. The method of claim 1, wherein determining the proximity link topology includes:
identifying the proximal network pair as being between one of the plurality of stations and a corresponding one of the plurality of access points that is a closest access point to the one of the plurality of stations based on at least one of the plurality of sensing measurements.

3. The method of claim 2, wherein the at least one of the plurality of sensing measurements is indicative of a motion in a sensing space associated with the Wi-Fi network.

4. The method of claim 3, wherein identifying the proximal network pair further includes:
in an analysis period including a plurality of motion detection windows that each includes a plurality of locating sampling instances,
identifying, for the plurality of locating sampling instances, a corresponding plurality of network devices closest to the motion in the sensing space from the plurality of stations and the plurality of access points;
for each motion detection window, identifying a plurality of network pairs, each network pair including one station and one access point from the plurality of network devices;
for the analysis period, summing a number of occurrences of each of the plurality of network pairs; and
designating, as the proximal network pair, a selected one of the plurality of network pairs having a largest number of occurrences from among the plurality of network pairs that share a station.

5. The method of claim 3, wherein the motion in the sensing space is selected from a plurality of detected motions as a motion closest to one of the plurality of network devices.

6. The method of claim 4, further comprising:
for a filtering window including the analysis period and a plurality of additional analysis periods, summing a number of occurrences of each of the plurality of network pairs in the filtering window; and
redesignating, as the proximal network pair, a new selected one of the plurality of network pairs having a largest number of occurrences from among the plurality of network pairs that share a station.

7. The method of claim 1, further comprising:
identifying an overlapping coverage area defined by selected ones of the plurality of stations having non-corresponding communication links and proximity links.

8. The method of claim 1, wherein the overlap ratio is defined as a ratio between a first number of selected ones of the plurality of stations having non-corresponding communication links and proximity links and a second number of the plurality of stations.

9. The method of claim 1, wherein identifying the Wi-Fi network adjustment is further based on the overlap ratio exceeding an overlap ratio threshold.

10. The method of claim 1, wherein the Wi-Fi network adjustment includes at least one of:
a frequency band change,
a modulating coding scheme change,
a transmission power reduction,
a beamforming adjustment, and
a network parameter change,
the method further comprising:
transmitting the Wi-Fi network adjustment to one or more selected access points from the plurality of access points.

11. The method of claim 10, further comprising determining a new overlap ratio subsequent to transmitting the Wi-Fi network adjustment.

12. A system for Wi-Fi network evaluation, comprising a networking device operating within a Wi-Fi network including a plurality of stations and a plurality of access points, the networking device including at least one processor configured to execute instructions for:
identifying a communication link topology of the Wi-Fi network, the communication link topology being defined by a plurality of communication links, each communication link being between an associated pair from the plurality of stations and the plurality of access points;
receiving, by the networking device, a plurality of sensing measurements measured according to the communication link topology;
determining a proximity link topology of the Wi-Fi network based on the plurality of sensing measurements, the proximity link topology being defined by a plurality of proximity links, each proximity link being between a proximal network pair from a plurality of network pairs from the plurality of stations and the plurality of access points;
identifying an overlap ratio based on the proximity link topology and the communication link topology; and
identifying a Wi-Fi network adjustment based on the overlap ratio.

13. The system of claim 12, wherein determining the proximity link topology includes:
identifying the proximal network pair as being between one of the plurality of stations and a corresponding one of the plurality of access points that is a closest access point to the one of the plurality of stations based on at least one of the plurality of sensing measurements.

14. The system of claim 13, wherein the at least one of the plurality of sensing measurements is indicative of a motion in a sensing space associated with the Wi-Fi network.

15. The system of claim 14, wherein identifying the proximal network pair further includes:
in an analysis period including a plurality of motion detection windows that each includes a plurality of locating sampling instances,
identifying, for the plurality of locating sampling instances, a corresponding plurality of network devices closest to the motion from the plurality of stations and the plurality of access points;
for each motion detection window, identifying a plurality of network pairs, each network pair including one station and one access point from the plurality of network devices;
for the analysis period, summing a number of occurrences of each of the plurality of network pairs; and
designating, as the proximal network pair, a selected one of the plurality of network pairs having a largest number of occurrences from among the plurality of network pairs that share a station.

16. The system of claim 14, wherein the motion is selected from a plurality of detected motions as a motion closest to one of the plurality of network devices.

17. The system of claim 15, wherein the at least one processor is further configured for:
for a filtering window including the analysis period and a plurality of additional analysis periods, summing a number of occurrences of each of the plurality of network pairs in the filtering window; and
redesignating, as the proximal network pair, a new selected one of the plurality of network pairs having a largest number of occurrences from among the plurality of network pairs that share a station.

18. The system of claim 12, wherein the at least one processor is further configured for:
identifying an overlapping coverage area defined by selected ones of the plurality of stations having non-corresponding communication links and proximity links.

19. The system of claim 12, wherein the overlap ratio is defined as a ratio between a first number of selected ones of the plurality of stations having non-corresponding communication links and proximity links and a second number of the plurality of stations.

20. The system of claim 12, wherein identifying the Wi-Fi network adjustment is further based on the overlap ratio exceeding an overlap ratio threshold.

21. The system of claim 12, wherein the Wi-Fi network adjustment includes at least one of:
a frequency band change,
a modulating coding scheme change,
a transmission power reduction,
a beamforming adjustment, and
a network parameter change,
the method further comprising:
transmitting the Wi-Fi network adjustment to one or more selected access points from the plurality of access points.

22. The system of claim 21, wherein the at least one processor is further configured for determining a new overlap ratio subsequent to transmitting the Wi-Fi network adjustment.
